(19) United States
(12) Patent Application Publication
(10) Pub. No.: US 2024/0417933 A1
(43) Pub. Date: Dec. 19, 2024

(54) Treatment, transport, and spreading of biological matter and treatment of ground surface

(71) Applicant: Roy Erik Eriksson, Oslo, MN (US)

(72) Inventor: Roy Erik Eriksson, Oslo, MN (US)

(21) Appl. No.: 18/744,651

(22) Filed: Jun. 16, 2024

Related U.S. Application Data
(60) Provisional application No. 63/521,359, filed on Jun. 16, 2023.

(51) Int. Cl. E01C 9/00; B64G 99/00; E01C 19/20

(52) U.S. Cl. CPC E01C 9/001; B64G 99/00; E01C 19/20

(57) ABSTRACT

The invention is generally for making it possible for anyone to travel to space, Moon, and Mars as a diamond. More specifically, the invention relates to the separation and compression of carbon from any biological matter and create at least one diamond. And from a Control Center administer the transport and spread of diamonds in space, or on a celestial body after that the spacecraft has landed. Or from above the celestial bodies so that the diamond lands within specific coordinates, and here called a resting place. Where the ground surface can be partly compressed and allow the diamonds to be visible on the surface and illuminated with invisible infrared light. And by compressing the landing site and roads so avoids problems with dust where the astronauts travel, while the resting place with its peaceful light from the Moon and or Mars can be seen from the Earth.

### TECHNICAL FIELD

The invention is generally to enable all biological beings to travel to space and be on any celestial bodies in the solar system or beyond as a diamond. More specifically, the invention relates to the separation and compression of carbon from any biological matter from a living or dead organism and create at least one diamond. And from a Control Center administer the transport and spread of said diamond in space or on a celestial body after that the spacecraft has landed, or from a location in space above the celestial bodies so that the diamond lands within specific coordinates, and here called a resting place. And where the ground surface on the celestial bodies can be partly illuminated with infrared light and compressed to make the diamonds visible and avoid problems with dust on landing sites for spacecrafts and connecting roads.

### BACKGROUND OF THE INVENTION

Many live far from the resting place their loved ones are buried in and cannot visit the cemetery as often as they would like. In addition, it is common for families to be separated into different continents, and no one has all their relatives buried in the same cemetery. It would also be desirable that dead relatives and friends who are buried can be honored at the same time, wherever they are and without any future costs. Manny also know that no one will care for or visit their grave when they die, and others are worried that their grave will be a burden for coming generations. There are also many who would like to travel to one or more celestial bodies in the solar system while they are still alive, but who cannot do so at today's cost.

Grave maintenance is also a frequent theme for trouble in many families, and often ends with one or a few people accounting for the entire cost and work of planting new flowers and the like, and when those people also die, no one often wants to take over and results in the removal of the tombstones. And they are removed unless someone wants to pay and is the usual procedure after the peacetime of about 20 years. Many believe that burial in a cemetery provides an eternal resting place, but the reality for many is only said peacetime. Many also appreciate that the burial site is illuminated with grave lights during evenings and nights, and the most evocative and which is often sought is the imitation of the moonlight, which is the moon's reflection of sunlight.

It would also be desirable if the inevitable future funeral could be designed so that those who so desire cannot become a burden on relatives and future generations and have a resting place that does not become overcrowded. It would also be desirable to have a resting place for people from all over the world, and also for animals. And that all humans can see the resting place wherever they are on Earth at predictable times, or from other celestial bodies or when traveling in the universe. Thus, there is a need for both an alternative burial place, as well as the fact that even living people often want to travel to other celestial bodies while they are still alive. The invention also possesses numerus benefits and advantages over known techniques when landing and working on the Moon and Mars, for example when spreading the remains, by reducing problems with the sticky dust most celestial bodies is covered by. And makes it easier and safer to travel on said celestial bodies, for example, between a landing site for spacecrafts and a resting place for biological remains. The above problems shows that there is a need for burials or spreading of remains in a clean form in space or on other celestial bodies without said negative effects being likely to occur, and at a lower cost and a more appealing form than current methods.

### DESCRIPTION OF PRIOR ART

A common method today is that burial takes place by throwing or spreading the ashes out of ships or aircrafts, and then usually over the sea. It is also known to bury the dead from a spacecraft, and many wish to be buried on other celestial bodies, especially on the Moon and Mars. And in 1999, NASA's Lunar Prospector spacecraft carried the ashes of astronomer Eugene M. Shoemaker in a small capsule and crashed the spacecraft with the ashes on the Moon after completing the mission. And there are companies that have said that they will start transporting dead people to the Moon and burial them there, but this has not yet been implemented and it can be assumed that corpses or scattering of ash would also. be in conflict to the international agreement not to pollute the Moon or Mars. It is also expensive to transport matter from Earth to the Moon, and it would of course be an advantage if the weight can be minimized while making matter less bulky, so that more burials or spreading of remains from dead or living individuals can be made by each spacecraft. At the same time, it would be a great advantage if the remains can be in a pure form and that does not allow itself to be mixed or otherwise contaminate area outside the burial site. It would also be an advantage if containers are not needed to encapsulate the remains on the resting place as this also constitutes an unwanted contamination at the resting place.

It is also very expensive and requires extensive logistics to land on the Moon as this in most spacecraft designs requires a separate landing module, which after that the burial has been carried out must then rise from the lunar surface and be reconnected with the spacecraft orbiting the celestial bodies. It would also be desirable if the resting place could be placed on a small, limited area and which for much of the time is illuminated by the Sun and can be seen from Earth. While matter added to the Moon should only occur in limited areas without affecting adjacent areas, and that no ash or any other remains from the deceased is at risk of swirling up and spread over the Moon's surface in the event of, for example, a meteorite impact. And with biological matter is meant here especially carbon from any living or deceased organism. The method of making artificial diamonds from carbon was invented 1953 in Sweden by a team around Erik Lundblad at ASEA. Anyone who wishes can today have a deceased's body cremated into ashes and have the carbon separated from other matter, and then compress and heat the carbon into a diamond. And, of course, the remaining ashes can be buried in the traditional way if desired. This method is currently used to preserve part of the deceased as a persistent memory. The human body consists of a total of 18% carbon and an average of 12.6 kg per person. Cremation diamonds can also, for example, be made of hair and to make a diamond on two Carat, about 10 grams of hair is enough. The data here was taken from the website of Lonite, which manufactures said cremation diamonds.

The following is a list of the amounts of hair or cremation ashes from the deceased required to turn their ashes into diamonds by the company Lonite, and they state that the ashes into diamond process requires this amount for all their different size of cremation diamonds from 0.25 carat to 2 carat. The diamond synthesis equipment they use requires a standardized amount of carbon to transform ashes into diamonds. The size of the diamond is determined by the time spent in the synthesis equipment. Each of the amounts listed below are enough to create up to three diamonds out of the included carbon, depending on the diamond sizes ordered from this company.
Cremation ashes 8 ounces (200 gram).
Cremated bones 10 ounces (300 gram).
Hair 0.4 ounces (10 gram).

And several countries and private companies have spacecraft and technology for transporting goods to space and delivering goods to any location in space, for example to a specific orbit or a specific location on a celestial body. And all spacecrafts launched into space transports some form of goods, here also called cargo, and by commercial actors often referred to as payload, that is simply the reason why it is considered worth the cost. And spacecrafts sent into space today are automatically controlled by computer programs and is of course a must if it doesn't have a human pilot. How a spacecraft works and is controlled is described in detail online, for example in NASAs SCIENCE website. There is information of all different equipment and how it works. And on the website to “Space Launch Schedule” all known launches into space are recorded with time, load, and data about the spacecraft all the way back to 1957 to the present, as well as all countries known planned launches. A lot of useful information about the space and spacecrafts can also be found on the website of Spacetv.net and on Great SpaceX.

It is, of course, not necessary for a user of this innovation to build and operate their own spacecraft. Today most of they who want to send cargo of any kind to space are not building their own spacecraft and instead hire the service from an existing space company, for example from SpaceX, NASA, ROSCOSMOS, ESA, Boing, Arianespace, Astra Rocket Company, Blue Origin, Rocket Lab Ltd, Sierra Nevada Corporation, United Launch Alliance, Ariane Group, Virgin Orbit or from a Space Organization from Canada, China, Indian, South Korea, Saudi Arabia or Japan. And against a charge the mentioned space companies build/adapt the spacecrafts cargo-container to the cargo the customer wants to send to space (see for example information on SpaceX). For the transport to space the customer only needs to tell the space company howe and where in space they want to place/spread the here called cargo, and the necessary calculations to achieve this can be done by the space companies' experts. But for those who feel they must send the cargo with their own spacecraft and have the right knowledge and a lot of money can do so with, for example, information and references mentioned here and in existing patents. Launching spacecrafts into space is still expensive and difficult, but the cost today is only a fraction of what it would have been if all space companies themselves were forced to develop the basic requirements for spacecrafts, computer programs and requirements specifications for the missions they want to perform in space, such as traveling to a specific orbit and there performing a specific task. And if they were forced to perform the necessary calculations for the entire spaceflight. All this information is currently available on the internet and if they want the spacecraft and made computer programs tested, these services can be purchased by NASA, and is the reason why so many private space companies today have the capacity to send spacecrafts into space. NASA's new mission is to help private actors develop and take over the state's previous role, and where the goal is that more private actors will lead to increased competition and thus lower freight prices to space. And leading players believe that shipping costs will drop to a tenth of today's costs in the near future.

Especially NASA and Russian ROSCOSMOS have access to an enormous data base about everything related to spacecrafts and all the data for the calculations carried out to date, and in addition, both space companies have access to the top scientists in everything related to space. Said space companies as well as researchers at some universities have developed formulas to calculate basically everything a space company needs to know to be able to send an autonomous spacecraft into space and perform any task at any location in the solar system at a specific time. And by sharing their knowledge, NASA aims for private actors to take over a large part of the state's costs for the space program and is therefore very helpful in disseminating knowledge to both the public and private companies of virtually everything related to space. For example, how the exact position of celestial bodies is calculated and how a spacecraft should travel to get to a specific orbit, as well as specific requirements for spacecrafts for different missions. And, for example, instructs companies in basic and advanced design of both spacecrafts and computer programs to automatically operate the various moving parts of the spacecraft and, for example, what orbits, speeds and precise corrections are needed to reach the desired trajectory at the desired time. NASA has also rocket propulsion test service that can be purchased by private companies.

And, as an example, so has NASA made available all the data from the first moon landing with Apollo 11, in 1969, and where the entire process of both the lunar lander and the orbiting spacecraft can be followed second by second where every change of speed and orbit is described in detail. The technology and equipment have of course been continuously specialized and refined, referring here to several patents that show how various problems have been solved to send a spacecraft into space and or place a payload in a selected orbit. Or navigate and, for example, orbit or land on the moon or mars. There are also lots of patents that describe the design and performance requirements of the spacecraft itself and how it is launched into space. There are also patents that describe how and with what equipment a spacecraft can land on another celestial bodies, as well as how and examples of equipment to orbit the moon, mars, or the Sun. There are also patents on equipment and computer programs to calculate the spacecrafts exact location/position in space and direct a spacecraft to, for example, a specific orbit and there perform specific task on specific location in said orbit, such as opening a container and placing GPS satellites in a specific orbit or activating a camera or other censors on said specific location in space, for example when orbiting a specific celestial bodies. For some research spacecrafts, the equipment can be permanently attached to the spacecraft, and usually they also carry smaller probes that at a specific location in space are released from a transport container to orbit or land on a celestial body or asteroid. Commercial players can with each spacecraft place lots of different types of objects on a specific place in a specific orbit, for example SpaceX places over 50 internet satellites in different designated locations in space with each spacecraft they launch. All the spacecrafts transporting cargo to space or, for example, landing on a celestial body is today automatically controlled by computer programs and can perform their programmed tasks at, for example, a fixed place and time.

SpaceX's website also contains information on how something they call a flip maneuver is performed where the booster is turned 180 degrees from the direction of travel with the help of several air nozzles to then use the rocket engines to slow down the speed and then land the booster at the chosen location. And the flip maneuver is also performed by Blue Origin when landing their boosters from higher altitudes and there are also patent applications on doing a flip maneuver when landing a booster. Information about the Falcon spacecraft is also displayed on SpaceX website and provides data on the spacecraft and various aspects associated with sending a spacecraft into space with here called payload, and how these can then be flown to and delivered at specific location in chosen orbit. Examples of standardized mounts and drop-off devices are also given, and state that the container/shipping space can also be adapted as desired.

Today, several countries can launch spacecrafts into space and some of the leading players are now private companies, and there are at least five countries, including ESA, which have sent probes to Mars. And anyone with sufficient funding can today hire some of these space-companies to send payloads to space and can use the already existing apparatus and knowledge in this companies and let said companies build and operate the spacecraft and send the payloads to the desired location and there perform the desired work. And attached information also shows that a smart person with the necessary knowledge of here called spacecrafts and space and plenty of money can use known technology to build a spacecraft, and if desired have it inspected and evaluated by NASA. And launch it into space to the desired orbit, and place in a designated location in said orbit a substance or object from a container by for example opening a hatch, valve, or nozzle in ways already known for this action. It is also known technology to make a flip maneuver or turnaround the spacecraft in any direction and make any change in direction of travel and can be done with all today's spacecrafts. For example, it would be impossible for a spacecraft to dock with the international space station ISS without this technology. And is carried out using nozzles placed on the sides of the spacecraft, where a computer unit then distributes compressed air from a container so that the desired pressure on the spacecraft is created on the opposite side to the desired direction of movement, and then carefully stop the rotation by activating air nozzles on the other side which is of course monitored by the spacecraft's location sensors. And it's known technology to make a map of the ground surface of a celestial body and to use radar, camera, and other sensors to identify and determine various objects and the like on a celestial body when flying past, by comparing incoming data with stored data in a storage-device. And, to determine the spacecraft's location in relations to said determined location for objects or areas and identify which known objects or area that the spacecrafts censors register during the orbit.

It is of course also known to orbit a celestial body with a spacecraft and from said orbit determine different tasks that should be performed on specific location(s) in said orbit. And of course, to land a spacecraft or a landing module on a determined place on a celestial body and after landing to operate an automatic vehicle and to travel and perform different tasks on specific locations on the celestial bodies surface with said vehicle. And of course, to communicate with a Control Center located on the Earth and that the Control Center can monitor censors and control the apparatus, for example the spacecraft or a vehicle on the celestial bodies ground surface. Spacecrafts normally send information and pictures back to Earth using the Dep Space Network (DSN), NASA also use the DSN to send lists of instructions to the spacecrafts. And ESAs Moonlight initiative will create telecommunication and navigation service with a constellation of satellites around the Moon, and one goal is to equip spacecrafts and Lunar rovers with Moonlight receivers so they can navigate autonomously with high accuracy, for example when landing or on the Lunar surface.

It is also known from earth to place objects on a specific landing site from a passing aircraft, for example to waterbombing forest fires by carrying water in a container and opening a nozzle on a specific location so that the water land on the fire. Or deliver goods to areas without roads or especial for military purposes, for example air bombing of specific targets with bombs that can't change direction by itself, so-called dumb bombs. And to hit the target the aircrafts altitude, speed, direction of flight and the gravitational forces acting against the bomb is used in the calculation when the bomb should be dropped. And when shooting the bomb also the extra created speed on the bomb and the determined shooting angle/direction is used to decide where and or when the firing should take place. Also, air resistance and strong wind can influence where the specific bomb should be dropped or shoot. The equipment used to drop or shoot the projectile or other type of bomb is of course developed for each specific bomb, but the principle is usually the same. Hitting stationary and moving targets from a place above the earth's surface is also used by many types of birds using the eye's optical ability to position objects, to then bomb precisely said objects through muscle contraction of organs containing feces. And to do the same in free space or on other celestial bodies existing equipment and calculations can be used but, of course, with adaption to the specific celestial body's conditions, for example the gravity of each celestial bodies, air density and that the altitude and speed of a spacecraft in an orbit is significantly higher than for an aircraft under normal circumstances. And the equipment must also be designed to handle any difference in air pressure in the spacecraft and the atmosphere outside which may affect the speed and direction of delivery of the selected diamond or object to be sent to the celestial bodies or, for example, from an orbit around the moon.

Low lunar orbit (LLO) is orbiting below 100 km (100 000 meter) altitude. They have a period of about 2 hours. They are of particular interest in exploration of the Moon but suffer from gravitational perturbation effects that make most unstable and leave only a few orbital inclinations possible for indefinite frozen orbits, and useful for long-term stays in LLO. A free-falling diamond on the Moon accelerate with 1,623 m/s2 and after falling 10,000 meters, the diamond has a speed of 180 m/s (648 km/h) and correspond to the speed of a bullet from a weak air rifle. And has then traveled for 111 seconds to achieve this speed and the diamond will most likely be buried in the soft surface layer. Since both the moon and Mars have a very fine-grained surface layer, there is quite little chance that the diamonds will be visible on the surface, even in those occasions where they bounce off the surface after impact. All the things on the moon will only weigh 16.6% as compared to what they weigh on earth such if someone's weight on earth is 100 kilos then on the moon, the weight will be 16.6 kilo. A free-falling diamond on Mars accelerate with 3,722 m/s2 and after falling 10,000 meters, the diamond has a speed of 272 m/s which corresponds to 982 km/h and has then traveled for 73 seconds to achieve this speed.

Also, construction of paved roads has been proposed on the moon and mars, but these solutions require large amounts of materials, and a simpler solution would be preferred before the celestial bodies become populated. A user of this invention can be a person or any form of organization and is expected to either operate a spacecraft and all equipment or hire experts for this, for example a space company that can deliver the diamonds on desired location and operate all equipment described in the invention. And a user and or said hired experts can also build and operate a spacecraft as described in this invention with knowledge to be found on patents and, for example on the website of NASA, ESA, SpaceX, and Blue Origin. And assumed to be updated to known technology and therefore can build and operate a spacecraft and automatically fly it and land on a specific place on, for example the moon or mars, or make the spacecraft perform a flip maneuver on a specific location on a chosen distance from, for example said celestial bodies and on a specific location in space activate a specific organ. For example, open a nozzle or valve connected to a container and deliver one or more objects trough said nozzle or valve at said designated specific location in space or after the spacecraft has landed on a celestial body. And use known technology and equipment to build/use and, when necessary, from Earth remotely control and maneuver all the various types of vehicles and said equipment sent and used in space and on the celestial bodies.

### DESCRIPTION OF THE INVENTION

It is an object of the invention to provide a method and an apparatus to enable all biological beings to travel to space and be on any celestial bodies in the solar system or beyond as a diamond. More specifically, the invention relates to the separation and compression of carbon from for example ashes from any biological matter from a living or dead organism originated from Earth and create at least one diamond of at least a minimum degree of purity. And from a Control Center administer the transport and spread of said diamond in space or on a here called celestial bodies after that the spacecraft has landed, or from a location in space above the celestial bodies so that the diamond lands within specific coordinates, and here called a resting place on, for example, the Moon or Mars.

It is another object in at least one embodiment of the invention that the ground surface on the celestial bodies is at least partly illuminated with infrared light so it can be seen with aids from for example the Earth but invisible to the naked eye.

It is another object in at least one embodiment of the invention that the ground surface is compacted/compressed, and here with the same mining, to avoid that the diamonds disappear in the dust layer on the ground, and avoid problems with dust on said resting place, landing site, roads, and walking paths on the celestial bodies.

It is another object in at least one embodiment of the invention to provide a method and means to make diamonds of carbon from any biological matter, also called for example ashes, vegetables, corps, remains or body parts, and transport the diamonds in a spacecraft from the Earth to a location in space, or to another celestial bodies, for example to the Moon or Mars. And the invention also aims to make it possible for both dead and living people and animals to make their presence on any celestial bodies in the solar system without contaminate the celestial bodies. And by celestial bodies is meant here all kinds of free-flying objects in the solar system or beyond as well as objects orbiting other objects, often called moons.

It is another object in at least one embodiment of the invention that at least one diamond is made of carbon from a biological organism from another celestial bodies than Earth.

It is another object in at least one embodiment of the invention that a Control Center placed on Earth is the coordinator and supervise the spacecraft transporting the diamonds. The Control Center comprising a computer unit including a controller and a communication unit coupled to the computer unit. And where at least one remotely monitored and from said Control Center controllable apparatus, here also called a spacecraft is equipped with at least one container for transporting diamonds from Earth and which will later be spread in space or on at least one other celestial body in the solar system.

It is another object in at least one embodiment of the invention that by spreading of diamonds is meant here all forms of placement of diamonds, regardless of the method or device used, or number of diamonds or distance between each diamond. And regardless of whether the diamonds are spread/placed in any formation or in or on the celestial bodies ground, or if the said ground is prepared in any way, for example if the ground is compressed or the ground surface is painted. Or if the resting place is illuminated in any way, for example by visible light, or to the naked eye invisible light, such as infrared light.

It is another object in at least one embodiment of the invention that by container is meant here means for storage and transport the diamonds from the Earth to space or another celestial bodies and can be designed to prevent the diamonds from being contaminated, maximize the number of diamonds, and facilitate the spread of the diamonds from space over the celestial bodies or after the spacecraft have landed. The container can be designed as part of the spacecraft or removable and made of any suitable hard or flexible material, for example aluminum or plastic or any combinations of materials, and in any suitable size, form, or number. And equipped with sealable holes or other suitable openings for filling and emptying the container. Can also be provided with holes for the introduction of compressed air from a gas cylinder for creating a higher air-pressure inside the container than outside, where the gas valve and the organ for emptying the container can be opened and closed by electric motors, and which is controlled by the spacecrafts control unit. The container can also be equipped with an electrically activated vibrator to facilitate emptying through said openable organ, for example, a nozzle, hatch, or valve.

It is another object in at least one embodiment of the invention to manufacture the here called container, and in any suitable size, thickness, and material, for example metal, plastic, composites, carbon fiber or fabric and in any form or design, for example in the form of a tube, box, or a bag. And with any shape, number or type of holes, and any device for covering and opening said holes.

It is another object in at least one embodiment of the invention that the container to carry diamonds consists of a bag in any form that the astronaut then can carry on the celestial bodies, and made of any soft material, for example plastic, composites, or fabric.

It is another object in at least one embodiment of the invention that the diamonds are spread on the resting place by humans after that a spacecraft loaded with diamonds has landed on the celestial bodies. Where the landing of the spacecraft or the landing module takes place using technology and method known for this task, for example used by Apollo 11 or planed landings by NASA, SpaceX or Blue Moon or as described in here mentioned patents.

It is another object in at least one embodiment of the invention that a Control Center control an apparatus that comprises an automatic flying spacecraft and a controller coupled to the spacecraft. The apparatus further includes a spreading device coupled to the spacecraft; the spreading device configured to spread diamonds from free space, or from a path in orbit around the celestial bodies so that the diamonds land on a here called resting place on the celestial bodies. And a location sensor on the spacecraft is further configured to provide a sensor feedback signal to the controller for exact location, travel direction and speed of the spacecraft. The controller is configured to instruct spreading of at least one diamond from a specific location, travel direction and speed in said free space or from an orbit based on in a storage device stored information of at least one spreading location and navigate the spacecraft to said spreading location. The controller is further configured to activate the spreading device at said spreading location determined by a feedback signal from the location sensor, so that the diamond/s land on said resting place on the ground of the celestial bodies, and with determined boundaries within which the diamonds must land. If the diamonds are just dropped from an orbit so will the diamonds orbit the celestial bodies in about the same way as the spacecraft and, depending on speed and altitude, so will it be very difficult to calculate and hit optimal landing place, why the diamonds should be given a speed towards the celestial bodies' surface to shorten the distance the diamonds fly in the spacecrafts flying direction. If the container contains of, for example, 50000 diamonds and it takes 10 seconds to empty the container, and if the method of dropping or shooting from a high orbit is used, then the experts from NASA or ROSCOSMOS should be contacted and approve the apparatus and method before its used. Because if the diamonds are dropped in just a few seconds wrong time so can that mean that some diamonds land on the other side of the celestial bodies.

It is another object in at least one embodiment of the invention that the diamonds are spread on the resting place after that the spacecraft have made a so-called flip maneuver, where the jet engines are first turned off and air nozzles on the side of the spacecraft is then activated and press the spacecraft to turn around 180 degree and then brake by starting said jet engines again. And the spacecraft will then be able to stop and then travel in the same direction as it came. And calculated so that the place where the spacecraft stand still for a short movement is over the resting place and there drop or shot the diamonds trough the nozzle, and the diamonds will then fly straight down to the resting place. The spacecraft can go very close to the surface of the moon when doing this maneuver and will not be exposed to the same heat as on earth because of lack of atmosphere. The spacecraft can then accumulate speed to fly back to earth by orbiting the celestial bodies in for this known way. The flip maneuver is advantageously done with yet streams of compressed air in the same way as the SpaceX and Blue origin do with the booster to safely land them on the ground, and more on the maneuver can be found on the respective companies homesite. And all spacecraft use this technology today to stabilize and direct the spacecraft in the desired direction.

It is another object in at least one embodiment of the invention to make a flip maneuver and spread diamonds on a celestial body and that the time and distance it takes to complete a 180 degree turn in order to first stop and then travel in the same direction it came depend on the weight and speed of the spacecraft. And the power used on the jet engine during braking, as well as the number and pressure in the air nozzles used to push the spacecraft around. And decides when and where the flip maneuver should be started so that the spacecraft will be in the desired location over the resting place when it stands still for a short moment, and there releases the load of diamonds so that they land on the resting place. For example, so can air nozzles be placed on the underside near the nose and another air nozzle be placed far back on the upper side of the spacecraft and activated at the same time and push in opposite directions. There should also be nozzle or valves on opposite sides to stop continued rotation when the direction is approaching the desired one, otherwise so will the rotation continue. The size, shape and location of the resting place must of course be large enough for the equipment and method used, so that all the diamonds end up on the resting place. And the heat from the jet-engine is not a problem in the way it is in atmosphere where the spacecraft must travel in its own exhaust gases. Without an atmosphere, the hot exhaust gases will travel away at the same speed they leave the engine plus the speed of the spacecraft in the same direction. And if the spacecraft flying in a horizontal direction and does not have sufficient speed to counteract gravity, it will be pulled towards the surface. Why the flip maneuver should take place at a sufficient high altitude, and when it is stationary in the horizontal direction it will be in free fall towards the celestial bodies by the celestial body's gravity. And the diamond is here given a velocity to fall faster than the spacecraft with compressed air in the container and pushed out through the nozzle in the direction of the resting place, and so calculated that the spacecraft is above the resting place at this moment.

It is another object in at least one embodiment of the invention that the celestial bodies gravitational forces are compensated during the flip maneuver in that the spacecrafts jet engine(s) is angled slightly towards the celestial bodies during deceleration. And the braking force and the spacecrafts angle are adjusted to match the force of gravity. When and where the flip maneuver should be started depends on the spacecrafts weight, speed, and the jet engines braking ability and the celestial bodies gravity on the selected height and the resting place location, size, and form.

It is another object in at least one embodiment of the invention that the celestial bodies gravitational forces during deceleration on the spacecraft are compensated after the flip maneuver in that the spacecrafts air nozzles placed on the side against the celestial bodies are used to push the spacecraft upwards from the celestial bodies to be able to maintain an essentially horizontal flight direction after said flip maneuver.

It is another object in at least one embodiment of the invention that it relates to means and a method of mapping a celestial bodies surface and characteristics for later determining of at least one location for placing a resting place and is performed with a spacecraft having a controller. The method comprises receiving operating parameters through a user input of the spacecraft. The method further includes navigating the spacecraft through a path around the celestial bodies. The method further includes detecting intrinsic surface characteristics of the celestial body's material through a radar unit and or a camera unit coupled to the spacecraft, wherein the radar unit and or the camera unit is configured to scan and or photograph the surface material and landmarks, and wherein the radar/camera unit is further configured to provide a sensor feedback signal to said controller of the spacecraft. The method further includes creating a map of the land area of the celestial bodies flown over by the spacecraft, wherein the map includes location for detected intrinsic surface characteristics, wherein the map is configured to be later updated to include the location of at least one resting place to spread diamonds on. The method allows for the controller of a spacecraft to determine the location of the spacecraft through determining the distance and angle to the detected intrinsic surface characteristics, for example specific identifiable landmarks and or man-made structure or other markings on the celestial bodies.

It is another object in at least one embodiment of the invention that it relates to means and a method of transporting biological matter, for example remains from diseased in the form of diamonds from the Earth to the space or the surface of the Moon or Mars with a spacecraft that is monitored and supervised from a Control Center placed on Earth and comprising of the following steps: Determining the recruitments for the burial place, here called a resting place on the respective celestial bodies, for example on the Moon and Mars and determine, size, form and the location/placing of the resting place on said celestial bodies and determine its coordinates in a coordinate system. Separate carbon from ash or any biological matter from a deceased or living organism and make at least one diamonds of the carbon. Transport the diamond to the launch pad for the spacecraft. Place the diamonds in at least one transport container. Transport the container with the diamonds in a spacecraft to the location in space or the celestial bodies where the diamonds are to be spread. And depending on whether the diamonds are to be spread after the spacecraft have landed, in for landing procedures known way, or from space where the spacecraft is placed at a determined travel direction, height and speed, to hit the resting place with the diamonds. Where the diamonds are released/shoot from determined coordinates as the spacecraft passes these coordinates from a determined direction and speed. Depending on the selected method; the diamonds are spread on the resting place after falling from a spacecraft, or after the spacecraft have landed and later spread by a human or a machine/vehicle that collect and transport the diamonds from the spacecraft and spread the diamonds in or on the surface/ground on said resting place. Said machine can be automatically controlled and perform preprogrammed tasks or controlled by an operator located on earth.

It is another object in at least one embodiment of the invention to make an agreement with a person to complete at least one step/action on the future handling of the persons corps in order to create at least one diamond, and transport of the diamond to at least one celestial bodies in the event of the person's death, comprising at least one of the steps of: Burning the corps or parts of the corps to ashes, collecting ashes, separating the carbon from the ashes, compressing the carbon into at least one diamond, transporting the diamond to space or a resting place on the persons selected celestial bodies, for example to the Moon and spread the diamond visible on or buried in the surface/ground material according to the persons wishes.

It is another object in at least one embodiment of the invention that at least one resting place is given a definite position and definite outer limits on the ground of the celestial bodies. The location for the resting place can advantageously be stated as definite coordinates in a coordinate system that comprises at least part of the celestial bodies. The size of the resting place should be adapted to the prevailing conditions for the specific celestial bodies and if the diamonds will be spread from an orbit or after the spacecraft has made a turnaround and for a movement stand still over the resting place, a so-called flip maneuver, or after the spacecraft has landed on the celestial bodies. And if the diamonds are dropped from an orbit so will the diamonds orbit at the same speed as the spacecraft and travel far from the dropping location before they eventually land. And where for example, gravitation and atmosphere will affect the most advantageous distance between the celestial bodies and the spacecraft when orbiting the celestial bodies, and long distance and low gravity can, for example, make it difficult to hit the resting place and means that the resting place must be made larger. And of course, large enough for the method and equipment to be used.

It is another object in at least one embodiment of the invention that it relates to a method to determine at least one resting place on at least one celestial bodies in the solar system by giving the said resting place a fixed location, here also called a specific location and specific borders, for example specific coordinates in a coordinate system, here also called a definite location and definite coordinates and whit the same meaning. And that the diamonds must be spread inside the borders/boundary of the resting place.

It is another object in at least one embodiment of the invention that here for simplifying reason called celestial bodies, for example the Moon or Mars, having at least one resting place with determined boundaries where diamonds can be spread. And where the location and design of the resting place is shown on a map comprising at least a part of the celestial bodies.

It is another object in at least one embodiment of the invention that it relates to use of a map to find a resting place and then spread diamonds on the celestial bodies. The map comprising of at least a part of a celestial bodies and boundaries for at least one resting place intended for spreading/placing diamonds.

It is another object in at least one embodiment of the invention that it relates to use of an already existing map of a celestial bodies and place at least one resting place with determined location and fixed borders on the map.

It is another object in at least one embodiment of the invention that it relates to use of a map of a celestial body with at least one resting place location marked on the map and use the map to find the resting place.

It is another object in at least one embodiment of the invention that at least one resting place on the moon and or mars has a size of at least one square meter.

It is another object in at least one embodiment of the invention that at least one resting place on the moon and or mars has a size of under one hundred square meters.

It is another object in at least one embodiment of the invention that it relates to determine a specific location to place at least one hardened landing site for spacecrafts on the Moon and or Mars and mark the location of the landing site on a map.

It is another object in at least one embodiment of the invention that it relates to use of a map of a celestial body with at least one hardened landing site for spacecrafts and which is ready for use and marked on the map and use the map to find the landing place.

It is another object in at least one embodiment of the invention that it relates to use of a hardened landing site for spacecrafts on the moon or mars by landing a spacecraft or landing module on the landing site.

It is another object in at least one embodiment of the invention that it relates to compress and harden the surface of the moon or mars where people or, any type of vehicle is expected to travel on the surface, in order to lover the problem with the extremely fine-grained soil on the surface. And roads for walking or driving can also be applied to a map.

It is another object in at least one embodiment of the invention that it relates to harden roads or walkways on the Moon or Mars for walking or travel on it by compacting the ground surface.

It is another object in at least one embodiment of the invention that it relates to the use of compacted and hardened roads or walkways on the Moon or Mars by walking or travel on it.

It is another object in at least one embodiment of the invention that the right-hand rule applies to oncoming vehicles on the compacted and hardened roads or walkways on the Moon and Mars.

It is another object in at least one embodiment of the invention that it is comprising a detection apparatus for finding a resting place and or a hardened landing site on the Moon or Mars and include a housing coupled to a spacecraft. The apparatus further includes a controller coupled to the housing. The apparatus includes a radar sensor coupled to the housing. The radar sensor is configured to scan the celestial bodies surface to locate intrinsic characteristic of the celestial bodies and wherein the radar sensor is further configured to provide a sensor feedback signal to the controller with respect to said intrinsic characteristic of the surface, geographical characteristics etc. The apparatus comprises a storage device coupled to the controller with a stored map comprising characteristics for the celestial bodies and the location for the resting place and or the hardened landing place. The in the storage device stored information comprises what speed the spacecraft should have and the exact location of said orbit regarding the direction of travel and altitude above the celestial bodies and where in the orbit either to start the landing procedure for the spacecraft, or where the dropping or shooting of diamonds is to take place, under these specific circumstances.

It is another object in at least one embodiment of the invention that the apparatus in the form of a spacecraft further includes a location sensor coupled to the housing. The location sensor is configured to provide a location feedback signal to the controller. The controller is configured to determine the location, speed and travel direction of the spacecraft and navigate the spacecraft to a place over the in a storage device stored location for the resting place or a landing site, and based on the location sensor feedback signal, for example a GPS system.

It is another object in at least one embodiment of the invention to manufacture diamonds from carbon from any living or dead organism, for example from humans, dogs, cats, horses, parrots, or flowers. And that the diamond is manufactured with determined and acceptable purity and quality according to requirements specification from the relevant authority. And can be stated in a scale adapted for this purpose for said purity/quality so as not to contaminate the celestial bodies. And the requirements can be standardized or different for different celestial bodies.

It is another object in at least one embodiment of the invention to establish and operate an organization or establishment for the control of purity and quality of diamonds to be transported to the moon or mars, and for example equipment and materials intended to be placed on a specific celestial body, or on a specific location on said celestial bodies.

It is another object in at least one embodiment of the invention that the spacecraft is using a location system to navigate in the form of a coordinate system such as GPS satellites and or GPS transmitters placed on the ground of the celestial bodies in order to land on the celestial bodies or locate the resting place for placing diamonds on it from an orbit or after the spacecraft has made a flip maneuver.

It is another object in at least one embodiment of the invention that the spacecraft navigate and locate the resting place and or a hardened landing site by using radar sensors and or camera sensors by identifying in a map stored instinct characteristics of the celestial bodies, for example rock formations, craters, level differences, etc. And or placed markings on the celestial bodies surface such as signal- or lighthouses, reflective materials, etc. The resting place and the landing site are placed in a map and marked relation to said identifiable markings on the ground and stored in the spacecraft's computer unit.

It is another object in at least one embodiment of the invention that it relates to a method for spreading diamonds on only a specific area on the celestial bodies, for example from a place in space over the celestial bodies and protecting the rest of the celestial bodies from contaminations from Earth and comprising the following steps: Determine location for at least one resting place for diamonds on a specific celestial body. The resting place location stored in a storage device and, for example, in a coordinate system including the celestial bodies; And coupling a controller to a spacecraft capable of automatic flying to a specific location over the celestial bodies; Coupling a spreading device to the spacecraft, the spreading device configured to spread at least one diamond from a specific location over the celestial bodies and make the diamond land on the resting place; Coupling a location sensor to the spacecraft, the location sensor configured to provide a location feedback signal to the controller, and wherein the controller analyzes the location feedback signal to determine the direction of travel, speed, and location of the spacecraft; And, wherein the controller is configured to: Determine a designated spreading location based on the sensor feedback signal and in a storage, unit stored information for at least one location from which said diamonds can be spread from a specific location and speed. And navigating the spacecraft to the determined spreading location; Activate compressed air nozzles on a specific location and make a flip maneuver and turn-around the spacecraft and activate the jet-engines in the opposite direction so that the spacecraft for a movement stands still over the resting place; And instruct spreading of diamonds at the designated spreading location by opening the nozzle and where compressed air in the container pressing out the diamond's trough said nozzle.

It is another object in at least one embodiment of the invention that it relates to an apparatus and a method for spreading diamonds in space from a container in a spacecraft equipped with spreading device where the diamonds are spread after an electric motor open a nozzle or a valve mounted on the container. To facilitate the spreading of diamonds so can the container be connected to a gas container that spreads gas in the container and creates a higher gas-pressure inside the container than outside and press and drag the diamonds out from the container. The spreading device can also be constructed in ways described in patents for spreading objects in space.

It is another object in at least one embodiment of the invention that it relates to a diamond spreading apparatus comprising: An automatic flying spacecraft capable to fly to an orbit around a celestial bodies, for example the Moon; A controller coupled to the spacecraft; A spreading device coupled to the spacecraft, the spreading device configured to spread diamonds from an orbital path around the celestial bodies, and make them land on a resting place for diamonds; And that the resting place are configured to shelter remains from organic matter in the form of diamonds; A location sensor coupled to the spacecraft, the location sensor configured to provide a location feedback signal to the controller, and wherein the controller analyzes the location feedback signal to determine the direction of travel, speed, and location of the spacecraft; And, wherein the controller is configured to: Determine a designated spreading location based on the sensor feedback signal and stored information for at least one location in the orbit from which said diamonds can be spread at a specific speed of the spacecraft; And, means for navigating and moving the spacecraft to the spreading location over the celestial bodies; And, means for changing speed and direction of travel to stored information; And, means for instructing spreading of diamonds by open a nozzle and make the diamonds to land on said resting place from the designated spreading location.

It is another object in at least one embodiment of the invention that it relates to an apparatus in the form of a spacecraft to spread diamonds on a resting place and that a sensor feedback signals from the radar sensor and the location sensor are further provided to a control center located on Earth. The spacecraft future comprising a communication unit coupled to a computer unit including a storage unit and a controller; And, that the storage unit configured to comprise a value for limits of the resting place and a value for the preferred location to spread diamonds, i.e., spread the diamonds as close to an aimed landing point as possible; And at least one location transponder placed on the resting place configured to provide a location feedback signal to the controller on the spacecraft, wherein the controller analyzes the feedback signal from the location transponder and determine the spacecrafts exact location in relation to said location transponder and correlates the value to in the storage unit stored value for preferred value and limit value for where in space the diamonds can be spread. And, that the controller determines if the present determined location of the spacecraft needs to be changed, i.e., adjust coordinates and or speed for the spacecraft before starting to spread the diamonds.

It is another object in at least one embodiment of the invention that the apparatus comprises an automatic flying spacecraft having a container containing diamonds, and a controller coupled to the spacecraft. The spacecraft future coupled to a location sensor for navigating and land on the Moon or another celestial bodies in the solar system. The diamonds are later spread on a resting place by a space traveler or by an automatic wheeled vehicle moving on the ground and spreading the diamonds on the resting place by, for example, opening a hatch/nozzle in the container containing the diamonds. The diamonds can be spread visible on the ground surface or buried in the ground material.

It is another object in at least one embodiment of the invention that the diamonds are spread by an apparatus traveling on the celestial bodies surface comprising an automatic diamond planting or spreading machine for transporting and spreading diamonds on a resting place on a celestial body. And modified to the conditions on the Moon or Mars and the machines movable parts can all be electrically operated and can place/spread diamonds visible on the ground surface or buried in the ground. The machine can, for example, when not in use be placed on a charging station with a battery connected to a solar panel placed close to a landing site for spacecrafts. The diamonds can, after the spacecraft has landed, be blown through a pipe from the container in the spacecraft to a container on the diamond spreading machine, or the container with diamonds can manually or automatically be lifted to the machine and attached to its feeding system to the planting-arms.

The spreading machine can be autonomous or controlled from Earth, for example in the known manner and equipment NASA controls its rovers on Mars. After spreading so can the machine return to the charging station. The machine is advantageously also equipped with vibrator or a roller to compress the topsoil layer on the Moon and Mars which is so fine-grained that it can almost be compared to dust. The here called ground surface is advantageously compressed on at least a part of the resting place and on the landing site for spacecrafts and on roads and walkways, and this is preferably done before people arrive to reduce problems with dust.

It is another object in at least one embodiment of the invention that the apparatus comprises an automatic flying spacecraft capable of flying to an orbit around a celestial body, for example the Moon. And a controller on the spacecraft coupled to a storage device with stored coordinates for a specific orbit to fly over a specified resting place with stored coordinate, and stored speed the spacecraft should have in the specified orbit and stored coordinates for where to activate the spreading device. Where the controller coupled to the spacecraft navigate the spacecraft by, for example, activating a throttle for one or more jet engines, and the location is determined by location sensor coupled to the controller and can navigate the spacecraft to said specific orbit around the celestial bodies and at a specific speed. The controller then activates the spreading device at said specific location in the orbit so that the diamonds leave the container and fall against the ground on the determined resting place.

It is another object in at least one embodiment of the invention that a spacecraft is equipped with organs to land on the ground on the celestial bodies and deliver diamonds at the landing site.

It is another object in at least one embodiment of the invention that a spacecraft from an orbit around the celestial bodies sends a landing module down to a landing site and that the landing module is equipped with organs to land on the ground and deliver diamonds at the landing site after landing. And then, with jet engines, return to the orbit around the celestial bodies to be reconnected to the spacecraft. And where the landing on the celestial bodies can be carried out with, for example, known technology from previous lunar voyages and landings on the Moon and Mars.

It is another object in at least one embodiment of the invention to collect carbon from a living organism for creating diamonds to later be sent to space or the Moon or Mars.

It is another object in at least one embodiment of the invention to collect carbon from a diseased person for creating at least one diamond to be sent to space or to the Moon and or Mars and that the rest of the corps can be buried in any traditional way on, for example the Earth or in space.

It is another object in at least one embodiment of the invention that the collection of carbon from organic materials and creation of diamonds and transport to a spacecraft for further transport to a celestial body can be done in any suitable way, and with any suitable apparatus.

It is another object in at least one embodiment of the invention that the diamonds can be spread on or in the celestial bodies ground in any suitable way, and with any suitable apparatus.

It is another object in at least one embodiment of the invention that the transport of diamonds from Earth to space or the Moon or Mars can be done with any suitable apparatus, for example a rotating slung-machine or laser powered canons placed on the Earth.

It is another object in at least one embodiment of the invention that the transport of diamonds from Earth to space or the Moon or Mars can be done in any suitable way, and with any suitable apparatus.

It is another object in at least one embodiment of the invention that the diamonds are leaving the spacecraft with a speed higher than the speed created of the gravitation from the celestial bodies in free fall. And the diamonds can be pushed out after being placed in, for example a tube, and the overpressure can be created with, for example, gun powder or air pressure or a spring. And can be created according to the principle of a cannon or shotgun, where the diamonds correspond to the bullets.

It is another object in at least one embodiment of the invention that the angel and speed the diamonds hit the ground are adapted so that they either bounce and roll on the surface with a large angle so as not to be buried, or at a small angle where the diamonds fall more straight down and increase the possibility of being buried in the celestial bodies ground layers.

It is another object in at least one embodiment of the invention to make it possible to choose if the diamonds should be visible or covered in the ground by choosing if the diamonds should be spread on a soft or hardened surface on the celestial bodies resting place.

It is another object in at least one embodiment of the invention that all or part of the ground surface in at least one resting place is compressed/compacted and here with the same meaning. And done with for example, a vibrator or a roller towed/pulled by an off-road vehicle. And to increase the compression the weight of the roller can be increased by filling the roller with sand from the surface of the celestial bodies. The roller can operate according to the same principle as those used in agriculture to compress the soil, or to the motor-driven rollers used in the compacting of soil, sand, and asphalt in road construction. The roller can in one embodiment be constructed to be lowered from a rover with an electric motor and during work of compacting the ground so can the roller act as the front and or the rear wheels. And with the intention of reducing the risk of diamonds being hidden in the fine mineral particles that most celestial bodies are covered by. An alternative consists of a vibrator activated by an electric motor, and both can be drawn by an all-terrain vehicle, and can be designed for making a smooth surface or any pattern.

It is another object in at least one embodiment of the invention that all or part of the ground surface is compressed in, for example, a resting place and increase the possibility that the diamonds end up visible on the surface. And by compacting the ground surface in locations on planed future activity, the problems with upturned/swirling particles can be reduced when landing a landing module or a space craft, and when driving and walking on the surface of the celestial bodies. The surface of a landing site for spacecrafts and or roads or walkways on the moon and or mars can be compressed with, for example, a roller or an electric motor activated vibrator that vibrate the soil/surface. The vibrator can be moved by said automatic planting machine or built in the planting machine and lowered to the surface when in use. The vibrator can, for example, work after the same principle as the handhold vibrators used to compress sand when laying asphalt or stones on garage driveways and roads. In this way, compacted surface/ground can form paths and roads in order to more easily travel to different places on the celestial bodies to be visited, and to avoid the said troublesome dust particles. And not affect more of the surface of the celestial bodies than is necessary. And with road markings with direction and distance to, for example the resting place and the landing place and reduces the risk of getting lost when traveling on the celestial bodies.

It is another object in at least one embodiment of the invention to use hardened ground surface to prevent problem from dust when landing spacecrafts and or when working or traveling on the ground surface of a celestial bodies.

It is another object in at least one embodiment of the invention that all or part of the ground surface where people or vehicles are planned to travel is first compressed with, for example, a roller or a plate compactor, also called a vibrator, and pulled by an off-road vehicle. And, for example prevent the extremely sticky dust to stick on the astronauts' suits. And that the said roller or vibrator can be operated wirelessly from Earth in the same way that the automatic vehicles are controlled by NASA on Mars and prepare the ground for future expeditions.

It is another object in at least one embodiment of the invention that the apparatus for compressing the surface on a celestial body is equipped with an electric motor for propulsion and cameras for navigating, as well as transmitters and receivers for remote control of its movements and the performance of the compression of the surface. And is preferably carried out before people land on the celestial bodies to reduce problems with dust. The control and movements of the apparatus can be performed with the corresponding equipment and technology used by NASA for their vehicles on Mars.

It is another object in at least one embodiment of the invention to transport the equipment to compact/compress the ground surface on the moon and mars. And transported in a spacecraft to the celestial bodies from Earth, and comprising, for example, a roller or a plate compactor.

It is another object in at least one embodiment of the invention to make diamonds of carbon from biological organisms originating from Earth to be sent to space and a resting place on another celestial bodies.

It is another object in at least one embodiment of the invention to organize processing and transport of diamonds made of carbon from biological organisms originating from Earth to a spacecraft that should travel to space and a specific place on the moon or mars.

It is another object in at least one embodiment of the invention that the cost to each customer for transport and spreading of one or more diamonds on a specific celestial bodies depend on at least one of the following conditions: Carat/size of diamond/s, number of diamonds, spread/placed in space, spread/placed from an orbit, spread/placed after the spacecraft have landed, spread/placed visible on the ground or buried in the ground material or stored information in a readable storage device about the individual the diamond is made of.

It is another object in at least one embodiment of the invention that at least one diamond transported by a spacecraft and to be spread/placed on a celestial body contains at least one more matter than carbon.

It is another object in at least one embodiment of the invention to determine a minimum quality and or purity requirement for approval and that the diamonds must meet to be legally transported to a resting place on at least one celestial bodies.

It is another object in at least one embodiment of the invention to determine a minimum quality and or purity requirement for approval and that ash or any remains in any form from humans must meet to be legally placed on a resting place on a celestial body.

It is another object in at least one embodiment of the invention to manufacture diamonds in a quality that is approved to be spread/placed on at least one celestial bodies.

It is another object in at least one embodiment of the invention that at least one of the diamonds, is colorless.

It is another object in at least one embodiment of the invention that at least one diamond transported by a spacecraft and to be spread/placed in space or on a celestial body has at least one color.

It is another object in at least one embodiment of the invention that the diamonds mentioned in this innovation can have any form, size, quality, or color.

It is another object in at least one embodiment of the invention that the diamonds are joined with another material, for example gold, silver, or platinum.

It is another object in at least one embodiment of the invention that the diamonds have its natural form from the manufacturing process or is, for example, cut or polished to another shape or quality.

It is another object in at least one embodiment of the invention that at least one of the diamonds, is engraved with at least one letter, number, or symbol.

It is another object in at least one embodiment of the invention to write about placing diamonds made of carbon from organic matter in space or on the Moon or Mars in a readable media channel, such as newspaper, books, or internet.

It is another object in at least one embodiment of the invention to broadcast in any form and in any media about placing diamonds made of carbon from organic matter in space or on the Moon or Mars.

It is another object in at least one embodiment of the invention that the spacecraft to place diamonds in space or on the Moon or Mars is powered by at least one jet engine.

It is another object in at least one embodiment of the invention that at least one diamond has a specific size or carat, or any size or carat and placed on the resting place with any side of the diamond up or a specific side up.

It is another object in at least one embodiment of the invention to set up requirements to avoid contamination on the celestial bodies by contaminated diamonds, and that the diamonds then must meet these specific requirements for quality and purity to be approved to be spread on the celestial bodies.

It is another object in at least one embodiment of the invention that the location for the resting place is determined to facilitate the spacecrafts orbit around the celestial bodies and the journey back to the Earth, with as little change of direction as possible.

It is another object in at least one embodiment of the invention that the spacecraft to transport diamonds to the Moon or Mars is at least partially painted in at least one color.

It is another object in at least one embodiment of the invention that the spacecraft to transport diamonds to the Moon or Mars is at least partially in the color of the material is made of, for example stainless-steel, aluminum or carbon-fiber.

It is another object in at least one embodiment of the invention that at least one diamond is made from more than one person and or pets, for example, two people or a family that want to be together for ever in the diamond and spread on one or more celestial bodies.

It is another object in at least one embodiment of the invention that the packing of diamonds in the container can be done manually or automatically controlled by a computer program, where the packing can, for example, be optimized for the maximum number of diamonds and or to facilitate the spreading of diamonds from the container.

It is another object in at least one embodiment of the invention that the packing of the diamonds in the container is done by vibrating the container and or the contents.

It is another object in at least one embodiment of the invention that the spreading of the diamonds from the container in space is done by equipment used by space companies to place payloads in space.

It is another object in at least one embodiment of the invention that the container and equipment for dropping, ejecting, or shooting the diamonds can be made in any suitable material or combination of materials, for example aluminum, steel, plastic, or carbon fiber.

It is another object in at least one embodiment of the invention that the diamonds in at least one container to be transported to space are counted and or weighed and that the result is stored in a computer program.

It is another object in at least one embodiment of the invention to determine a specific location for at least one landing site for spacecrafts on the Moon and Mars, for example by giving the landing site specific coordinates. And make a landing site at said location by making the ground hard and even and that can withstand the weight of the landing module or the whole spacecraft, so that the support legs do not sink into the ground, as well as reduce uplift of dust and sand at take-off and landing. The ground can be leveled using a dozer blade mounted on, for example, a spreading machine for diamonds and hardened using a vibrator or a roller that compress the ground, or by concrete in the same way as used for said landing site on Earth used by SpaceX and Blue Origin. The landing site can also be marked in any suitable way, for example with a painted white circle or a cross to improve visibility and facilitate the landings.

It is another object in at least one embodiment of the invention that at least one side of the diamonds are photographed under microscope and that the photograph is stored, for example, digitally and that it is stored together with information for identifying the origin of the diamond etc.

It is another object in at least one embodiment of the invention that it comprises a searchable data record of those spread as diamonds in space or on the Moon, Mars, and other celestial bodies. And may, for example, contain a death announcement about the deceased.

It is another object in at least one embodiment of the invention that it comprises a searchable data record and, for example, photos of people or animals or other organisms spread in space or on a celestial body as a diamond.

It is another object in at least one embodiment of the invention that a searchable data record comprises people or animals that at the time of spreading the diamond in space or on a celestial body is still alive.

The stored information may comprise standardized personal information and or information selected by the owner of the diamond.

It is another object in at least one embodiment of the invention that the register over, for example, people spread as a diamond in space or on a celestial body is stored with DNA code for that person.

It is another object in at least one embodiment of the invention that the information about a person spread as a diamond in space or on a resting place on a celestial body comprises a searchable family tree.

It is another object in at least one embodiment of the invention that the information about a person spread as a diamond in space or on a resting place on a celestial body comprises a website for communication between users of the website and or for listening to music.

It is another object in at least one embodiment of the invention that at least one resting place on at least one celestial body is given a name.

It is another object in at least one embodiment of the invention that the name on a resting place for diamonds on the Moon or Mars is used in advertising.

It is another object in at least one embodiment of the invention that diamonds made of humans and placed in space or on the Moon or Mars and or the name on a resting place is used to make a song or play that song.

It is another object in at least one embodiment of the invention that the burial place for a person is the name of the resting place and or the name of the celestial bodies the diamond is spread/placed.

It is another object in at least one embodiment of the invention that in the case when the remains from a person is used to make several diamonds and spread on different celestial bodies the burial place for the person should be al the celestial bodies the diamonds are spread.

It is another object in at least one embodiment of the invention that the location and size of a resting place is determined through an international agreement and consist of specific coordinates and whose boundaries may not be entered or exploited in a manner contrary to the said agreement.

It is another object in at least one embodiment of the invention that the resting place can have any form or size.

It is another object in at least one embodiment of the invention that the resting place can be placed anywhere on the celestial bodies.

It is another object in at least one embodiment of the invention that the resting place is placed to be lighted by the Sun and visible from Earth for as long time as possible.

It is another object in at least one embodiment of the invention that there are at least two resting places on at least one celestial bodies, for example intended for different species or countries.

It is another object in at least one embodiment of the invention to clean and sterilize the surface layers of diamonds from impurities, so that each diamond is as free from contaminants as possible and does not bring contaminants from Earth to the celestial bodies.

It is another object in at least one embodiment of the invention to transport the diamonds in a container that has been cleaned and free of pollution, as well as place said containers in a spacecraft for further transport to space or the Moon or another celestial bodies.

It is another object in at least one embodiment of the invention to advertise to the public that they can buy a ticket for at least one diamond to at least one celestial bodies, which is then to be sent to, for example, the Moon and or other celestial bodies in accordance with the invention.

It is another object in at least one embodiment of the invention to collect material to make a diamond of and or collect finished diamonds to be send to space or a specific celestial body and collect and store the information the sender of the diamonds wants to be publicly available after that the diamond has been placed or spread in space or on the celestial bodies.

It is another object in at least one embodiment of the invention to add or change stored information in a storage device and posted on the internet about spread diamonds from living people when said people later dies, if that's their expressed wishes, and can for example comprise place and date of death.

It is another object in at least one embodiment of the invention to manufacture and or operate a data register with information about, for example, the origin of each diamond spread in space or on a resting place on a celestial body. And, for example, make it available via the internet.

It is another object in at least one embodiment of the invention that any contracts entered can be insured by both sellers and buyers of the service of making and or transporting diamonds to space or a celestial body, if an unforeseen event occurs, for example if deadlines cannot be met or in the event of a breakdown of, for example, the spacecraft.

It is another object in at least one embodiment that the invention comprises a method and apparatus for a honeymoon travel by configuring the spacecraft for privacy for couples, so other members of the cru can't see what they are doing. And especially equipped for sex in weightlessness in space and, for example, qualify to be accepted in a club depending on the distance they have been from Earth. For example, traveling to at least one orbit around the Moon and qualify to be accepted into the 385,000-kilometer club or, for example, the Moon Club.

It is another object in at least one embodiment of the invention that the apparatus and method to spread diamond in the desired direction by turning/pointing one or more nozzles, or opening one or more gaps or equivalent, in the desired direction. And or turn the spacecraft with jet engines and or direct nozzles for air pressure so that said gaps or nozzles for spreading diamonds are directed in the direction the user wants to spread diamonds in the same way space companies spread/place payloads.

It is another object in at least one embodiment of the invention that the ground in at least one resting place is at least in part colored or painted in a light or reflective color, for example finely ground lime, white paint, snow or reflective paint or material. And intends to increase visibility from the Earth, for example when part of the Earth shadows the light from the Sun. The said cover material can be sprayed or spread on the ground, for example with an automatic spreading machine. Mentioned, but not recommended.

It is another object in at least one embodiment of the invention that the ground in at least one resting place is at least partially covered by a layer of snowflakes of water and made with a snow machine.

It is another object in at least one embodiment of the invention that the ground in at least one resting place is at least partially continuously filmed and in real-time shown on an internet channel.

It is another object in at least one embodiment of the invention to illuminate the ground surface of the resting place with, for example, headlights where the power is collected from a battery, and which is charged using solar cells when the area is illuminated by the Sun. And intends to illuminate the resting place during all or part of the time the Earth shades the area. The lighting can be placed on poles or heights in the terrain and directed towards the ground/surface so that the light source itself is not visible from the Earth, only the illuminated ground with the spread/placed diamonds. The lack of atmosphere on the Moon also means that the resting place can be illuminated from far away.

It is another object in at least one embodiment of the invention to illuminate the ground surface of the resting place with headlights placed on at least one spacecraft orbiting the celestial bodies where the power is collected from a battery, and which is charged using solar cells when the spacecraft is illuminated by the Sun.

It is another object in at least one embodiment of the invention to illuminate the ground surface of the resting place with lights in any color or wavelengths, for example that the ground is illuminated with light that cannot be seen without aids, for example infrared light. Where anyone who so wishes can look at the resting place on the Moon with binoculars or cameras adapted to see infrared light. The resting place or other part of the celestial bodies can also be illuminated with lights in any color that's form any letters, numbers, symbols, or objects, for example for advertising. Illuminated surface can be imagined for example a flag, a cross, the resting place given name or the borders. Or an illuminated marking against the ground where the diamonds should preferably land, or, for example, one or more individuals' nationality and who is spread on the resting place as a diamond.

It is another object in at least one embodiment of the invention to offer and advertise to people who wish to travel around the Moon, for example, grieving relatives of the deceased to travel to an orbit around the Moon when the diamond is spread on the Moon. And or in combination with honeymoon traveler.

It is another object in at least one embodiment of the invention to coordinate the collecting of diamonds and arrange the transportation to a determined resting place at a determined time or period.

It is another object in at least one embodiment of the invention that it relates to a diamond spreading apparatus. The apparatus includes a spacecraft and a controller coupled to the spacecraft. The apparatus further includes a spreading device coupled to the spacecraft. The spreading device configured to spread diamonds from an orbit around a celestial body. The apparatus includes a radar sensor coupled to the spacecraft. The radar sensor is configured to scan the celestial bodies surface to a search for stored intrinsic characteristic for a resting place with specific location and size, for example location lighthouses or signal transmitters, wherein the radar sensor is further configured to provide a sensor feedback signal to the controller with respect to an intrinsic characteristic of the celestial bodies surface. The controller is configured to calculate and compare incoming data with stored data and with this calculate the exact location of the spacecraft. And at a specific spreading place at said specific altitude, speed, and direction, instruct opening of a nozzle based on the feedback signal and spread diamonds through the nozzle so they will fall on a resting place on the celestial bodies surface.

It is another object in at least one embodiment of the invention that it relates to a diamond spreading apparatus. The apparatus includes a housing coupled to a spacecraft. The apparatus further includes a controller coupled to the housing. The apparatus includes a radar sensor coupled to the housing. The radar sensor is configured to scan a celestial bodies surface in search for surface characteristic (e.g., mountains, formations, altitudes, lights, for example reed laser light pointed at the surface etc.,) wherein the radar sensor is further configured to provide a sensor feedback signal to the controller with respect to found and localized intrinsic characteristic of the surface. The apparatus further includes a location sensor coupled to the housing. The location sensor is configured to provide a location feedback signal to the controller. The controller is configured to create a map of the celestial bodies surface based on the sensor feedback signal and the location feedback signal. The map is then used to determine at least one resting place on the surface of the celestial bodies and with determined boundaries for the resting place.

It is another object in at least one embodiment of the invention that an apparatus spread diamonds on a resting place after that the spacecraft have landed. The apparatus includes a spreading machine and a controller coupled to the spreading machine. The apparatus future includes a location sensor coupled to the spreading machine, for example a GPS system. The location sensor is configured to provide a location feedback signal to the controller. The controller is configured to navigate the spreading machine after information from in a storage device stored map of the celestial bodies and location of the resting place and at the determined location spread diamonds on or in the surface based on the determined placement and the location feedback signal.

It is another object in at least one embodiment of the invention to manufacture an apparatus for spreading diamonds on the moon or mars, for example fully automatic or equipped to be controlled wirelessly from the Earth. Here, for example, further developments of the Swedish patent SE508317 C2 can be used.

It is another object in at least one embodiment of the invention to manufacture a machine to compress/compact the soil on the moon or mars, for example fully automatic or equipped to be controlled wirelessly from the Earth.

It is another object in at least one embodiment of the invention that it relates to a method of spreading diamonds on a celestial body after first landing a spacecraft on the celestial bodies where the spacecraft comprising a controller. The method includes receiving operating parameters through a user input of the spacecraft. The method further includes navigating the spacecraft from Earth to the celestial bodies. The method further includes landing on the celestial bodies and the diamonds can be taken from the spacecraft manually and spread on the resting place by a human, or the human can place the diamonds in a radio-controlled spreading-machine that later can spread diamonds on or in the surface on a determined resting place.

It is another object in at least one embodiment of the invention that it relates to an apparatus and a method of operating a diamond spreading machine including a controller. The machine is configured to scan the surface characteristics and spread diamonds on at least one resting place. The method includes detecting intrinsic surface and ground characteristics with a GPR unit coupled to the spacecraft, wherein the ground penetrating radar unit is configured to scan the celestial bodies surface material, and wherein the radar unit is further configured to provide a sensor feedback signal to a controller with respect to the intrinsic ground characteristics. The method further includes, in response to the intrinsic celestial bodies' characteristics, instructing a spreading mechanism coupled to the spacecraft to spread/place diamonds above or in the ground at the desired depth. And with selected distance between previously placed diamonds and those being placed. If desired, the location of each diamond can be stored and displayed on a map, with the name of each person placed as a diamond. In order to perform the identification, each diamond must be photographed under a microscope and stored in a storage unit and made searchable by the machine's computer unit. Then each diamonds features must be identifiable by the spreading machines camera and computer unit, and upon identification the location of said placed diamond is stored with exact coordinates. Alternatively, each diamond with a known origin can be stored in a numbered compartment in a magazine, where then each placed diamond from each numbered compartment is stored with coordinates and the said diamonds known origin.

It is another object in at least one embodiment of the invention that it relates to a method of spreading diamonds from an orbit around a celestial body, for example the Moon and from a spacecraft having a controller. The method includes receiving operating parameters through a user input of the spacecraft. And further includes a location sensor coupled to the housing and configured to provide a location feedback signal to the controller. The method further includes navigating the spacecraft through a path orbiting the celestial bodies. The method further includes detecting the location in said orbit from which said diamonds should be dropped or shot in order to hit the resting place on the ground of the celestial bodies, wherein the controller unit is configured to activate a spreading device and spread said diamonds at said location in orbit.

It is another object in at least one embodiment of the invention that at least one sensor includes at least one camera for determining of, for example, the landing/resting places for the diamonds, and here also called a resting place, and where the shape and size correlate with stored information in a storage device. And advantageously by several cameras that take pictures in different wavelengths. By comparing a series of images, it can also be calculated exactly where the spacecraft is located, direction of travel and speed in relation to identified structures and the like. And based on obtained and stored information calculate where the resting place is and if necessary, activate jet engines to adjust, for example, the direction of movement or height above the celestial bodies, the speed and where and when the diamonds are to be released or pushed out to land in the resting place. The information is routed to the Control Center in the same way as for all other censors on the spacecraft.

It is another object in at least one embodiment of the invention that it is comprising a hardened landing site and an apparatus that include a housing coupled to a spacecraft. The apparatus further includes a controller coupled to the housing. The apparatus includes a radar sensor coupled to the housing. The radar sensor is configured to scan the celestial bodies surface from an orbital path around the celestial bodies to find the location for the landing place, wherein the radar sensor is further configured to provide a sensor feedback signal to the controller with respect to an intrinsic characteristic of the landing site, geographical characteristics etc. The apparatus further includes a location sensor coupled to the housing. The location sensor is configured to provide a location feedback signal to the controller. The controller is configured to correlate stored data of a map of the celestial bodies with the sensor feedback signal and the location feedback signal. The method further includes, in response to the intrinsic landing site characteristics, instructing a landing mechanism coupled to the spacecraft to land the spacecraft on the landing place.

It is another object in at least one embodiment of the invention that it relates to a method for coordination of spreading of diamonds on celestial bodies, comprising; Collecting diamonds from people that want to send them to a specific celestial bodies; Sorting the diamonds after travel destination, for example to the Moon or Mars; and, placing the diamonds in at least one container; Connecting at least one container to a spacecraft; Transport the diamonds to a determined orbit around the chosen celestial bodies; and, that the landing/resting place is under the said orbit; and, determine the spreading place in said orbit by a location system; Spreading the diamonds from said orbit on determined location and speed; and, placing the diamonds to rest at said resting place.

It is another object in at least one embodiment of the invention that it relates to the use of a celestial bodies to create at least one resting place and reduce the risk of polluting and damage the celestial bodies in accordance with any of described apparatus and methods, and where the diamonds placements on the resting place is agreed and insured.

It is another object in at least one embodiment of the invention to manufacture the container to store diamonds and or manufacture the spacecraft to transport diamonds.

It is another object in at least one embodiment of the invention to manufacture and transport the rocket fuel and other supplies to the spacecraft, which will transport the diamonds to the Moon and or Mars.

It is another object in at least one embodiment of the invention to manufacture and use of computer programs, radio transmitters/receivers, censors, and other equipment necessary for communicating and monitoring a spacecraft for transporting and spreading diamonds on the Moon or Mars and controlled from at least one Control Center located on Earth.

It is another object in at least one embodiment of the invention that at least parts of a spacecraft are painted or covered in a non-reflective black color to avoid reflection of sunlight against populated celestial bodies or manned spacecrafts.

It is another object in at least one embodiment of the invention to manufacture and install computers and computer programs in said spacecraft and landing module and, for example, the spreading apparatus for diamonds and intended to control and regulate the moveable organs of the respective devices and to communicate with the Control Center located on Earth with the communication device.

It is another object in at least one embodiment of the invention that one or more of the spacecrafts tasks described in the invention and or tasks they perform can be insured against damage or interruption of said task, based, for example, on the estimated value of the work performed over a specified period, and or the cost of replacing each spacecraft or landing module or machines operating on the surface of a celestial bodies with a new one. And where the premium per period can be determined based on both historical and estimated future downtime of the actual vehicle model, as well as where in the estimated lifespan each vehicle is located.

It is another object in at least one embodiment of the invention that movable organs on the spacecraft can be controlled by the apparatus data unit and, if necessary, over-controlled or reprogrammed or updated via a data unit located at the Control Center located on Earth.

It is another object in at least one embodiment of the invention that the spacecraft is equipped with the corresponding technology and equipment used in lunar voyages, but adapted to carry diamonds, in at least one container, and equipped with computer programs to automatically influence the spacecraft's jet engines to drive to in a computer unit programmed orbit around the celestial bodies.

It is another object in at least one embodiment of the invention that the spacecraft is equipped with computer programs, computer device and positioning/location equipment for automatic determination of speed, direction of movement/travel and precise position/location, as well as sensors for recording the celestial bodies and Earth's location in relation to the apparatus, according to known technology used in space travel.

It is another object in at least one embodiment of the invention that the spacecraft is equipped with sensors for monitoring all movable organs and the status of the spacecraft, and that said movable organs can be adjusted to the desired status or optimal status as necessary.

It is another object in at least one embodiment of the invention that the spacecraft for spreading diamonds have at least one other mission to perform on the celestial bodies or under the transport to or from the celestial bodies, for example transport passenger or payloads.

It is another object in at least one embodiment of the invention to enable the spacecraft to dock with another spacecraft or landing module for example in according to the method, process and equipment used by today's space shuttles docking with the ISS, or lunar lander docking with the launcher in orbit around the Moon. Where the intention is to be able to transfer, for example, fuel, diamonds and other supplies for operation and maintenance.

It is another object in at least one embodiment of the invention to have a stationary landing module placed on the Moon and on Mars, and capable of flying back and forth between the celestial bodies and an orbit and dock with approaching spacecrafts with cargo to the celestial bodies. When transferring cargo from the spacecraft, the landing module can also be filled with fuel.

It is another object in at least one embodiment of the invention that the container is funnel-shaped towards the nozzle to prevent the diamonds from sticking to the inside walls when they are to be spread.

It is another object in at least one embodiment of the invention to vibrate and or blow in the container with compressed air to facilitate spreading through a nozzle and prevent any diamonds from remaining in the container.

It is another object in at least one embodiment of the invention that the design of the nozzle on the container can consist of a lid that can be opened with an electric motor. The lid can also be designed to be opened by a spring, or to keep the led closed by a spring and opened by creating a strong overpressure in the container using expanding gas from a gas cylinder.

### SUMMARY OF THE INVENTION

The invention is generally to make it possible for everyone to travel to space as a diamond. And comprises an apparatus and methods for administering, manufacture and transport diamonds from Earth and spreading the diamonds in space or on any object in the solar system or beyond, and here called celestial bodies and comprising the Moon and Mars.

By transforming carbon from a living or dead organic organism into a diamond so will not the celestial bodies be contaminated. And a diamond is strong and durable and can withstand being released or shot from a high altitude and takes up little space and simplifies transportation, as well as reduces shipping costs and is aesthetically pleasing. And at least one resting place for the diamonds is preferably placed so that it is visible from Earth for as long as possible. And with biological matter is meant here especially carbon from any living or deceased organism originating from earth.

The invention also makes it possible for living persons to travel to the Moon, Mars and other celestial bodies and permanently stay there, or just float away in space as a free soul. Which can be very satisfying for people interested in the universe. And with a celestial body is meant here any object in the universe that can be reached by a spacecraft traveling from Earth. A deceased here means a human or for example pets, and all who want can rest at a here called resting place. With biological and organic matter is meant here all or parts of a dead or living organism containing carbon and which in this invention are treated to extract the carbon and manufacture a diamond. Now living and future relatives can feel the psychological feeling of closeness to their loved ones just by looking at the celestial bodies. And future generations will not have to look after a grave and the costs of this. The Moon and Mars reflection of sunlight at night also means that the light can be perceived as a grave light, and that they never have to feel guilty for not visiting or laying flowers on the grave. A diamond can be perceived as a reflective star, and for many it will be an appealing feeling to know that they one day will travel to one or more celestial bodies. And if the resting place is illuminated with infrared light, the resting place can be seen with binoculars or cameras developed for this, even when the Sun is not shinning on the resting place. The carbon can be taken from body parts from both living and deceased people, animals, or plants. The carbon is after separation exposed to extremely high pressure until it is converted into at least one diamond, in for this known way, but where the requirement for quality should normally be lower than in the manufacture of industrial diamonds.

(One carat equals to 0.2 g (200 mg). If we assume that a 2-carat diamond each occupies up to one cubic centimeter, depending on its often-irregular shape, then at least 1000 diamonds can be accommodated in a cubic decimeter, (1 liter). Which means that at least 1,000,000 diamonds can fit in a cubic meter of cargo space, and if each diamond weigh 0.4 g the cargo will then weigh up to 400 kilograms. And means that even a small spacecraft can carry a load of diamonds from one million people or pets or whatever a person wants to send to space or a celestial body as a diamond. And if the shape were optimal, the number of diamonds could be more than doubled for the corresponding volume.

No diamond is completely like any other diamond in strong magnification, which is why images taken of a diamond under a microscope also can be used to connect the diamond to a specific individual, and in the future, for example 100,000 years from now, be used to identify who the specific individual is at the resting place. The device can therefor also be equipped with identification capabilities by photographing the diamond under a microscope and then storing taken photos with information about the individual the diamond is made of.

Many people who wish to be buried on the Moon and or other celestial bodies can use this method to do so already while living, for example by sending their hair to make one or more diamonds, and then send them to the resting place on one or more celestial bodies. And for those who so desire, they can send a diamond to all the celestial bodies in the solar system. Of course, you can also send diamonds from your living loved one in the same way, as well as pets or other organisms containing carbon. The positive thing about the method described in this invention is not only the satisfaction it gives to the individual, but that it can make space travel to other celestial bodies profitable and promote technological development and thus, for example, passenger transport and mining activities on other celestial bodies. The transportation of diamonds to other celestial bodies can also be in combination with other missions, for example exploration, space tourism, transporting goods or necessities to or from the celestial bodies.

To spread the diamonds on a celestial body the diamonds must either be spread from ground level after the spacecraft has landed or from a spacecraft in space over the resting place. And preferably after performing a 180-degree so-called flip maneuver to slow down the spacecraft and for a moment stand still above the resting place and there spread the diamond by, for example, open a hatch/valve/nozzle to the container and with an overpressure created by gas from a gas bottle push the diamonds out of the container so that they fall to the resting place. The diamonds can also be spread from an orbit around the celestial bodies after determining the specific location, speed, and direction, and where the distance between the spacecraft and the celestial bodies must not be higher than that the gravitational force from the celestial bodies is strong enough to make the diamonds travel path predictable and not risk miss the resting place. Or the diamonds can be spread from longer distance if they are leaving the spacecraft in a determined direction by a force adapted to the distance to the resting place and the speed of the spacecraft. The diamonds can, for example, be shot towards the resting place according to the corresponding principle used for the bullets in a shotgun or a cannon. The pressure to push the diamonds away through a tube filled with said diamonds can be created by, for example, air pressure or explosives, for example gunpowder.

Where, for example, one or more diamonds are dropped or shot directly from the spacecraft towards specific coordinates on the celestial bodies, such as the Moon, with an estimated and determined drop rate for the entire travel path to, in this example, the surface of the Moon. Of course, the calculation basis for when the diamonds are to leave the spacecraft to land in the desired location or in a specified area also includes the location for the spacecrafts orbital path, speed of the spacecraft, and distance of the spacecraft to the surface of the celestial bodies, as well as the gravity of the celestial bodies and any rotational speed and the direction of movement of the spacecraft in relation to the direction of rotation of the celestial bodies. Where, of course, the celestial bodies rotation around its own axis becomes of little or no importance when released from low altitude or if the diamond is given high speed. And, for example, the Moon's rotation is locked to Earth and always shows the same side during its orbit around the Earth.

When the diamonds must leave the spacecraft depends on how far the diamond will fly in the direction of travel before landing and depends on several factors. For example, if the diamonds are released or pushed out of storage containers at a speed, as well as the speed of the spacecraft, the distance between the spacecraft and the celestial bodies, the celestial bodies gravity, any atmosphere that will then slow down the movement in the direction of travel and that increases with reduced distance to the celestial bodies. Thus, the optimal distance between the celestial bodies and the spacecraft when releasing the diamonds is determined by the celestial body's gravity and atmosphere. Furthermore, the orbit around the celestial bodies should be laid so that as few side movements as possible needs to be made when the spacecraft enters the celestial bodies gravity and then leaves it on its way back to Earth. It also means that the resting place on the ground should advantageously be laid below this line. And in the case of the Moon, an orbit on or near the center of the Moon, as seen from Earth maximizes the gravitational forces on the spacecraft and means that the Sun illuminates the resting place for a long time. For other celestial bodies that have not locked rotation to Earth, the resting place should be laid so that for as much of the time as possible it is facing Earth. The size of the resting place must, of course, also be adapted to the difficulty of hitting it from an orbit around the celestial bodies so that diamonds do not end up outside the set limits of the resting place. I suggest for the Moon a resting place that is 15 kilometers long in the spacecraft traveling direction and 5 kilometers wide, but where the goal is to hit the center of the resting place.

When also space tourists are traveling in the spacecraft, several orbits should be offered to give travelers greater benefit from the journey, for example for honeymoon traveler so they also have time to see the Moon. The Earths gravitation on the Moon makes it difficult to place satellites orbiting the Moon on higher altitudes than 750 miles or 1207 km, and the problem increase because of that the Moons mass concentration, often called the mascon's, affect satellites at low orbits. And makes it difficult to place GPS satellites orbiting the Moon because that they will not stay in the orbit for longer periods, but the GPS can be placed on the celestial bodies surface. Spacecraft can correct its path in an orbit and the lack of atmosphere means that the spacecraft can travel close to the surface and means that the spacecrafts altitude can be very low in order to determine the diamonds optimal fallrate. As example of ways for dropping or shooting diamonds against the resting place technology and means used for dropping or shooting bombs from aircrafts at specific targets here on Earth can be used.

The time of flight for a diamond from the container in the spacecraft to the surface of a celestial bodies depends on the height above the said surface, and the celestial bodies gravity as well as the initial velocity magnitude for the spacecraft. And if the diamonds are given an extra speed in any direction, and if so, the speed and angle of the diamonds' movement as they leave the spacecraft. Here, for example, the spacecraft can travel in a horizontal direction while the diamonds are pushed in the direction of the surface of the celestial bodies. For example, if it takes 10 seconds to empty the container of 50,000 diamonds, a spacecraft in orbit will travel several kilometers during this time, although it is of course possible to make a maneuver where the spacecraft paces quite close to the surface. As an example, the Apollo 11 Lunar orbit altitude was over 96 kilometers and the velocity over 1600 m/sec.

Therefore, I suggest that the spacecraft perform a so-called flip maneuver over the resting place and perform a loop and turn the jet-engines in the direction of travel and activate them so that the spacecraft is slowed down, and for a short time thus stands still over the resting place and there activates the valve/nozzle on the container. So that it opens while compressed air in the container helps to blow the diamonds out of the container with the direction of the resting place. When the loop is to be performed for the spacecraft to be able to leave the diamonds from a place above the resting place of specified size and extent depends of course also on the speed and braking ability created with the chosen number of jet-engines. The spacecraft, of course, does not have to stand completely still throughout the emptying if the size of the resting place is adapted to the precision made possible by the equipment and method used. From a more or less stationary spacecraft, the diamonds can be dropped from high altitude with great precision, and orbits around the celestial bodies can then be used in a known way to increase the speed of the return trip to Earth.

When the spreading of diamonds takes place from ground level after the spacecraft has landed, the entire process of spreading can be filmed and broadcast live to Earth, and when spreading from an orbit around the celestial bodies, the spacecraft orbiting the celestial bodies and the actual release of diamonds from the spacecraft can be filmed. Furthermore, all vehicles for traveling on the celestial bodies and places for stationary activities should be monitored by camera and broadcast live to Earth. Location determination of the location of the spacecraft and the location of the resting place on the celestial bodies can be done with GPS or equivalent systems if the celestial bodies and its surroundings are provided with this system. As well as the star-trac system where several cameras record several known star's exact location in relation to the spacecraft, and a computer unit then calculate the exact location of the spacecraft. And even digitally stored maps and photographs can be used and are used today to determine the location of robots on the Moon and Mars surface and is also used to determine the exact position of spacecrafts relative to the celestial bodies surface when spacecrafts shall land or orbit the celestial bodies. A common method used today is to determine the location of the spacecraft in space by determining the location in relation to a specific celestial bodies or specific places or objects on said celestial bodies. Here can for example be used laser measurement of for example distance and angle to one or more specific location for known objects or points on the resting place or its surroundings.

To be able to spread diamonds on a celestial body we first must determine at least one here called resting place for diamonds on at least one celestial bodies, and that the resting places size, design, and location is approved by the relevant international authority. The resting place location is advantageously provided in a coordinating system, for example according to the GPS system or equivalent systems. Where, GPS satellites orbit the celestial bodies and operate according to the same principle as on Earth with specific coordinates for each location on the celestial bodies surface, as well as the ability to determine which coordinates a spacecraft is on in said coordinate systems, as well as the direction and speed the spacecraft moves in said coordinate systems. Said GPS systems can also consist of corresponding equipment that is placed in a GPS satellite but placed with ground contact on said celestial bodies, for example in four corners of a resting place or in the surroundings, and which receives power from batteries and solar panels, and which must of course be dimensioned so that the GPS system works even when the location is not illuminated by the Sun. In this example, the GPS devices located on the celestial bodies surface communicate with the spacecraft approaching the celestial bodies in the same way that GPS satellites circling the Earth communicate with GPS devices on or around Earth. When the spacecraft comes within range of communication with the satellites, distance to each of them is determined and the exact location, direction of motion and speed can be calculated in the same way as with GPS navigation here on Earth. The resting place, for example, can form a 15-kilometre-long and 5-kilometre-wide area, where then diamonds can be spread from ground level or dropped from satellites orbiting the celestial bodies. If the diamonds are spread at the resting place after landing, this can be done by the space traveler or by robots. For example, the diamonds can be spread by a wheeled or banded transport vehicle that then drives to the designated resting place and spread the diamonds above or in the ground and then returns to the landing site of the spacecraft.

Identification of a resting place can also be done with, for example, a camera system that identifies determined resting place by, for example, in a storage unit stored map with information on specific characteristics for the area. The navigation system can also include a lighthouse-system working after the same principle as was used for ship traffic and air traffic before the GPS systems took over the navigation. Another way could be a laser placed on the spacecraft and a laser reflector placed on the celestial bodies, for example in the middle of the resting place. The spacecraft comes in with a pre-programmed direction, altitude, and speed. As soon as the reflector becomes visible, the laser is automatically directed and locked against the reflector, according to the technology known from military aircraft. Then, continuous distance and angle are measured, which shows the exact location of the spacecraft and allows corrections in the orbit and to release the diamonds at exactly the right moment.

The foregoing summary is illustrative only and is not intended to be in any way limiting. In addition to the illustrative aspects, embodiments, and features described above, further aspects, embodiments, and features will become apparent by reference to the drawings and the following detailed description.

### LIST OF ELEMENTS IN AT LEAST ONE EMBODIMENT

1. Control Center. Placed on Earth and monitors and controls the entire fleet of spacecrafts and continuously monitors the spreading of diamonds in space or on a resting place, and, if necessary, changes the work carried out to achieve the objectives set as effectively as possible. Monitors and influences or control spacecraft 3 and Landing module 23 and a diamond planting machine 31 and a combined or separate roller machine 7 or a vibrator 9. The Control Center 1 preferably operate and decide where the radio-controlled machines 31 and 7 and 9 should travel and where to place diamond respective compress the surface. As well as turning radio-controlled headlights 33 and cameras 82 on and off.

3. Spacecraft. Flying craft to transport diamonds 27 to space, and preferably to the Moon, Mars, or other astronomical objects, all of which here are called celestial bodies 59. And land on said celestial bodies or spread/release the diamonds at a chosen location in space so that the diamonds floats in free space. And the diamonds can also be spread from space so that they land on a specific place on a celestial body, for example, from a specific location in an orbit 61 around the selected celestial bodies 59, or after that the spacecraft 3 made a flip maneuver 63 after reaching the celestial bodies to reduce the speed and facilitate the spread of diamonds. The spacecraft can be designed and constructed according to known and proven technology used of, for example NASA, ESA, ROSCOSMOS from Russia, CNSA from kina, ISRO from India, JAXA from Japan and NURI from South Korea. And also, the private companies SpaceX, Boing, Blue Origin, United Launch Alliance and Astra have the spacecrafts, knowledge and technology to transport and deliver cargos at a specific orbit, speed and place in the space. The only thing that needs to be added in the spacecraft is a container 21 for diamonds. And if the diamonds are released from space also a nozzle 15 and a spreading mechanism adapted for the type of goods, in this case for diamonds, as well as an added routine in the computer program 49 for navigating to said desired location in space and there spread/release the diamonds.

5. GPR radar screen. Georadar registers obstacles and objects above and below the ground and can be placed on the diamond spreading/planting machine 31 and roller compactor 7 and plate compactor 9.

7. Roller compactor for compressing the surface of the celestial bodies and can be equipped with an electrically driven vibrator. Can be controlled by a human in the same way as is done on Earth, but preferably motorized and radio-controlled from Earth. Can also be towed/dragged after a vehicle in the same way as the roller used by farmers. The machine is equipped whit cameras and sensors for safe navigation known from for example Mars-rovers and comprises preferably GPS for continues logging of location and performed work. Preferably autonomous or a from Earth controlled machine. For compressing the ground surface to reduce the problem with dust on, for example landing sites 65 and roads 69 on the Moon and Mars and prevent the diamonds from disappearing in the dust on at least a part of a resting place 25. Both the Roller and the vibrator can be made to carry loads, for example sand or water, to increase the pressure against the surface, in ways known for the same equipment used on Earth to compress soil, sand or asphalt etc. Can be controlled in the same known way as, for example, radio-controlled spacecrafts in space and vehicles on the celestial bodies Mars.

9. Plate compactor and vibrator for compressing the surface of the celestial bodies. Can be controlled by a human in the same way as is done on Earth, but preferably motorized and radio-controlled from Earth. Can be made heavier by loading the roller with sand and controlled from Earth in the same way as roller 7 and Planting machine 31.

11. Planting arms. Controlled by electric motors in the same way as all other moving organs of this description, and for automatic or radio-controlled planting of diamonds on a specific location and connected to the diamond planting machine 31. Can be controlled in the same way as, for example, radio-controlled equipment placed on spacecrafts or vehicles on the celestial bodies Mars.

13. Diamond planting assemblies, attached to the planting arm 11 on the planting machine 31 and for planting the diamonds over or in the soil/ground 79 on the Moon and Mars. The start point of the planting assemblies may be a nozzle or hatch 15 connected to the container 22. But instead of that the nozzle 15 only cover a hole, the said hole can be connected to a flexible pipe through which the diamonds can be blown to the ground surface 79 so that the diamonds are visible or placed buried in the sand/soil/dust. And the air-pressure can be very low, especially on the Moon, because the weight on the moon is only 16% and nearly no atmospheric pressure. Then the planting machine of course must carry a gas-container 19 and connected to the container 22.

15. Nozzle or hatch. Preferably electrically openable means covering a hole in the container 21 and 22 for emptying the container of diamonds, the nozzle or hatch for example controlled by an electric motor. Can be designed for the diamonds to fall freely, or at a speed, for example blowing the diamonds out of the container with compressed air with the help of the spreading device in the form of gas from gas-container 19. Can in a spacecraft also be connected to barrel assembly 75 to fill the barrel with diamonds.

In the simplest version, only said nozzle or hatch needs to be opened and added air pushes and pulls the diamonds along in the direction the hole in the container 21 or 22 is directed.

16. air-nozzles. Placed on the sides of the spacecraft 3 and enables side corrections and flip maneuvers. And can be designed in the same way as on all spacecrafts used in space today, where, for example, number, location direction and performance on every air-nozzle 16 is optimized for the task to be performed by the spacecraft. The gas can be taken from gas-container 19.

17. Gas-taps Controlled by electric motors and with the help of which the gas from gas container 19 is regulated into at least one container 21 or 22. Preferably electrically controlled and can for example also be used for regulation of the compressed gas through the air nozzles 16 placed on the sides of the spacecraft and enables side corrections and flip maneuvers. Also used to control the inflow of gas and increase air pressure in container 21 and works the same way on equivalent equipment placed on the planting machine 31 and connected to container 22 to empty the container of diamonds.

19. Gas-container. And the compressed gas from the container/cylinder is here used as a spreading agent of diamonds and for emptying the container 21 and 22 and spreading diamonds trough a nozzle 15 or a valve on the resting place or in free space. Can be designed to spread diamonds 27 in space from a container 21 placed in a spacecraft 3. The principle also used on container 22 placed in or on a planting machine 31 and there the gas blows the diamonds through the machines planting assembly 13 to the ground. Of course, each vehicle can be equipped with several gas-containers 19 intended for specific function or backup in case of problems and consists of compressed gas of, for example nitrogen or oxygen.

21. Container. To store and transport of diamonds 27 and made of hard or flexible material, such as aluminum, carbon fiber, plastic, or textile. Where the number of container and size is adapted to the number of diamonds to be transported, and the specific spacecrafts design and available capacity. Can in a simple embodiment consist of a container with an openable valve/door for filling a certain number of diamonds, and a nozzle/valve 15 openable by an electric motor which is opened by the unit's controller when the diamonds are to leave the container from a specific location. At the same time, a gas taps 17 can also be opened to create an overpressure in the container 21 and facilitate emptying. Can also be designed to be managed and carried by a space traveler who after landing then spread the diamonds by hand on the resting place 25.

22. Container placed on the planting machine 31 can be designed with similar functions as container 21 and at the bottom of the container is preferably a flexible pipe attached through which the diamonds are blown and ending in the diamond planting assembly 13, and the pipe is attached to the planting arm 11. Can of course also be designed as machines with feeder system for planting seeds or plants here on earth.

23. Landing module. Transport diamonds 27 from the spacecraft 3 to the ground of a celestial bodies. Can be designed stationary on site, and lift and meet incoming spacecrafts without these having to land. And transport supplies and personnel to and from the celestial bodies 59 and said spacecraft.

25. Resting place. A place with determined borders where the diamonds must be placed as not to pollute the rest of the celestial bodies, and its location and boundaries are advantageously given coordinates and placed on a map 35 which includes at least part of the celestial bodies. And in at least one embodiment all or part of the ground surface 79 can be compacted/compressed with a roller compactor 7 or a plate compactor 9, and the diamonds can be placed visible or completely hidden manually or with an automatically controlled diamond planting machine 31 or from a spacecraft 3 from over the resting place.

27. Diamonds. Made of carbon from biological material originating from Earth and from any living or dead organism, for example humans, animals, or plants.

29. Jet engine. Refers here to both transport the spacecraft 3 and several small jet engines for location corrections of the landing module 23 and comprising a sensor for registering the amount of fuel in the fuel tank.

31. A diamond spreading/planting machine. Can be designed to be operated by a driver on the machine or for automatic planting of diamonds on the resting place 25. Or equipped for wireless control via radio signals from a control center 1 placed on Earth in a manner known for this purpose used by, for example, NASA. And each diamond can be placed on or in the surface material. Designed to be able to travel on the ground and, for example, after the principle of the Canadian patent CA2282672 C. And constitutes in this embodiment a manned or unmanned fully automatic vehicle for transport and spreading of diamonds on or in the ground material 79 on the resting place 25 in any suitable way and not restricted to the preferred embodiment. The diamonds can, for example, be poured directly from the container by angling an opening on the container downwards the ground. The machine 31 can also pull or be equipped with a roller compactor 7 or a plate compactor 9 for compressing the ground 79, for example, to and from the resting place and during the work on the resting place.

33. Headlights. Floodlights aimed at the surface of the Moon or Mars, for example light invisible to the eye such as infrared light. Can make the resting place 25 visible at night with aids but without disturbing others.

35. A map of the resting place on the Moon and Mars, and with advantage also a hardened surfaces such as landing site 65 for spacecrafts, and roads 69 and places on the celestial bodies surface 79 used by people. Can be provided with coordinates, boundaries for different areas etc. as well as names and numbers of roads 69 and objects and the like. And can of course be in both digital form and on paper in all known ways for maps 35.

37. Solar panels. Generate power for operation of, for example the diamond planting machine 31 and store power in battery located at the Charging station 67.

39. Transmitter/Receiver Connected to computer unit 51 at the Control Central 1, for wireless order giving and information exchange via antenna 72 with spacecraft 3, and other vehicles, for example the diamond planting machine 31 and the machines for compacting/compressing of soil by the roller compactor 7, plate compactor 9 or the charging station 67. And designed in a known manner for communication between a control center and a vehicle in space or on a celestial body used of, for example, NASA, SpaceX or ROSCOSMOS.

41. Transmitter/Receiver. Connected to computer unit 52 at the spacecraft 3 and landing module 23 for wireless information exchange via antenna 71 with Control Center 1, and other vehicles in space or on the Moon or Mars and designed in known manner used by space companies/organizations.

43. Radar arm GPR. Directs the GPR 5 and is rotatable and hinged and the movements of which are controlled by means of electrical circuits, and censors continuously measure angle in height and side. And placed on the planting machine 31 or a roller compactor 7, or a plate compactor 9. Can also be used to search for hidden objects below the ground surface 79 and possibly in combination with metal detectors. For example, when searching for valuable metals or construction materials.

45. Website. For stored information in a computer program on, for example, the name and origin of each diamond and when people or pets was placed in space or on the Moon or Mars and when they died and laid out on internet. Can consist of, for example, a chronicle of a person's life and information you wish to make available to future relatives etc. The website can also be designed in a standardized way but with the option to add personal information, images, video, family tree, data from DNA test etc. The information stored on the website can be made searchable by, for example, name, date of death or when the specific diamond was placed in space or on one or more celestial bodies and in any language. Can also be designed in the same way for animals and for living people. A website can also be designed as a club for those who are placed in space or on a celestial body as a diamond as they are space traveler and inhabitants of the Moon and or Mars.

47. Computer program located on Control Center 1. Computer programs and the necessary equipment for monitoring and controlling spacecrafts and rovers operating on for example mars are known technologies, therefore only features specific to this invention are described here. And comprise computer programs with stored preferred and desired values for, for example, location for placing, dropping, or shot diamonds 27 at a specific geographical location at a specified time. And where, howe and when the ground 79 should be compacted etc.

49. Computer programs placed on the spacecraft 3 with transmitter receivers for communication with Control Center 1, as well as functions to control and activate organs and functions of the spacecraft 3, and location themselves in relation to, for example, another spacecraft or Landing module 23. However, as this is known from today's spacecraft, this is not described in more detail. It therefore describes only functions specific to spacecraft with tasks described here. In particular, it is possible to send and receive information to determine the speed and direction of flight based on said resting place 25. And to control the amount of said diamonds 27 by, for example, activating the nozzle 15 to a specific position in a specified location for a specified time. As well as pointing a spreading device in the form of a nozzle or hatch 15, towards the selected area of the celestial bodies and shooting at the desired range and, if necessary, correcting the location of the spacecraft 3.

50. Controller/Computer unit. Placed in a compacting machine 7 and or 9.

51. Controller/Computer unit. Placed at Control Center 1. Comprising computer program 47.

52. Controller/Computer unit. Placed in Spacecraft 3. Comprising computer program 49.

53. Controller/Computer unit. Placed in a planting machine 31.

54. GPS-Antenna for a location determination system, for example GPS. Placed on the spacecrafts 3 and or the landing module 23.

55. GPS-Antenna for a location determination system, placed on a diamond planting machine 31.

56. GPS-Antenna for a location determination system, placed on the compacting machine 7 or 9.

57. GPS satellites or equivalent system in an orbit around the Moon or Mars. Said GPS equipment can also be placed on different places on the surface of the Moon and Mars. And of course, works in a known way. And ESAs Moonlight initiative can also be used and will create telecommunication and navigation service with a constellation of satellites around the Moon, and one goal is to equip spacecrafts and Lunar rovers with Moonlight receivers so they can navigate autonomously with high accuracy, for example when landing or on the Lunar surface.

59. Celestial bodies, or any celestial body for example the Moon or Mars. All celestial bodies, including moons, are here called celestial bodies. And includes the in the literature often called astronomical objects.

61. Orbit around a celestial body 59, and from which the diamonds 27 are released or pushed/shoot towards the resting place 25. But the high speed makes optimal placement of diamonds difficult and requires, for example, a significantly larger resting place 25 than the other proposed methods for spreading diamonds.

63. A flip maneuver over the surface of a celestial bodies 79. Turns the spacecraft 3 so that it travels backwards for a moment before stopping above the resting place 25 and there the diamonds are spread. And can then travel in the same direction it came, and this maneuver is done to slow down the speed and facilitate the spread of diamonds so that they land on the resting place 25. The maneuver can be performed by any spacecraft today, and it is only a new area of use for said maneuver that is intended. The spacecrafts computer program 49 can also be provided with instructions to point the jet-engine 29 diagonally downwards as speed decreases and the effect of gravity increases to maintain a constant distance to the celestial bodies surface. When the speed of the spacecraft is acceptable for the placement of diamonds within the approved location above the resting place 25, for example a nozzle, valve, or hatch 15 can be opened by an electric motor, and the diamonds are advantageously blown through said nozzle, valve, or hatch in the direction of the resting place 25. By using the overpressure in the container 21 produced by the supplied gas from the gas-container 19 by opening the gas tape 17.

65. Landing site for a spacecraft or landing module and hardened and flattened so they not when landing tip over or sink into the ground and prevent that dust swirls up. It will work for smaller landing modules 23, but for bigger spacecrafts 3 the part of the landing site holding the spacecraft should be made of, for example, armed concrete, and the surrounding area affected by the jet-engines should be compacted/compressed with the roller 7 or vibrator 9.

67. Charging station, connected to solar panels 37 and batteries, and with equipment for automatic connection and charging of batteries on a diamond spreading machine 31 and different rovers used on the Moon or Mars, for example roller 7 or vibrator 9 or rovers for transport or exploration. Preferably located close to a landing site 65 and within travel distance to a resting place 25.

69. Hardened Road, for example leading from the landing site 65 to the resting place 25 and preferably compressed with roller 7 or vibrator 9. By road is meant here also walking paths and other surfaces for work or travel on the Moon or Mars. Long and large hardened surfaces should be given local names and or numbers.

70. Antenna, on the compacting machines for communication with the Control Center 1 in for this presider known way.

71. Antenna, on the spacecraft 3 for communication with the Control Center 1. Trough the Transmitter/Receiver 41, connected to computer unit 52 at the spacecraft 3 and landing module 23.

72. Antenna, on the Control Center 1 for communication with spacecrafts 3 and all other vehicles and equipment in this application. Trough the transmitter/Receiver 39, connected to computer unit 51.

73. Antenna, on the diamond planting machine 31 for communication with the Control Center 1 in a known way via transmitter/receiver, not shown.

74. Radar arm, angles and points the radar 80, and in at least one embodiment placed on a spacecraft 3 or a planting machine 31.

75. Barrel assembly, refers to the loading mechanism and the firing mechanism as well as the barrel and which can be filled with diamonds, and which is then pushed towards the resting place 25. Calculating of shooting angle and location to shoot, charging and other functions can be designed according to the corresponding equipment and principle used by bombers used on Earth and on at least one embodiment placed on a spacecraft 3.

77. Barrel arm. Directs the barrel connected to the barrel assembly 75 in the calculated firing direction to hit the resting place 25 from determined specific orbit and speed and is controlled by electric motors.

79. Ground/soil/land surface/on a celestial body (59). And means, for example, the uppermost layer of the celestial bodies that can be walked on and in which diamonds are placed on or in. And can also be compressed or compacted, where both words here have the same meaning. Preferably the ground surface 79 is compacted everywhere where the dust can swirl up and cause problems. Especially in places like, for example roads 69, footpath, working areas on the ground and landing sites 65 or in at least one embodiment at least part of a resting place 25.

80. Radar. Distance analysis of, for example a celestial bodies 59 ground surface under the spacecraft when orbiting a celestial body to find a resting place 25 and or to positioning the spacecraft 3 in the determined orbit or when landing the spacecraft on the landing site. Can be used on celestial bodies which do not yet have GPS or equivalent systems.

81. Compacted/compressed area on the celestial bodies, for example the resting place 25 in order to make the diamonds 27 more visible.

82. Cameras placed on and or around the resting place 25 and around the landing site 65 and on all vehicles traveling on the celestial bodies, and on strategic places on the celestial bodies. Some of the cameras can be pointed at the universe for space observations. And all cameras can preferably stream the signal to Earth in real time in a way known for this field of use.

### DESCRIPTION OF THE DRAWINGS

The inventions will now be described in greater detail with reference to the accompanying drawings in which.

FIG. 1 shows a schematic view of an apparatus in the form of a spacecraft designed and equipped for spreading diamonds in space or on a resting place on a celestial body, in this example the Moon,

FIG. 2 shows a schematic view of the principal for a flip maneuver, and the spacecraft turning the jet engine to compensate the fall against the celestial body,

FIG. 3 shows a schematic view of a diamond planting machine,

FIG. 4 shows a schematic view of a charging station,

FIG. 5 shows a schematic view of equipment and parts described in the invention,

FIG. 6 shows a perspective view o a container for transporting and spreading diamonds,

FIG. 7 shows a perspective view of a digital map of a celestial body and a resting place, landing sites, roads and charging station and apparatus for transporting diamonds to space from earth,

FIG. 8 shows an example of a block diagram of electronic circuits included in the diamond planting machine,

FIG. 9 shows an example of a block diagram of a controller of the Diamond planting machine.

### DESCRIPTION OF THE INVENTION IN A PREFERRED EMBODIMENT

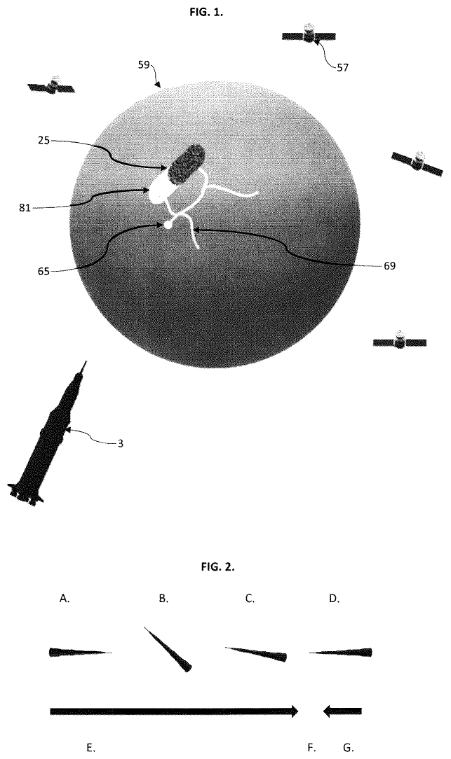

In the attached FIGS. 1-9 and in the list of elements the various main parts of the invention are described, and as a preparatory measure, one or more resting places 25 suitable for spreading diamonds 27 on the Moon and Mars should first be determined and its outer limits given coordinates and placed on a map 35. The size of the resting place 25 should at least adapt to the method of spreading the diamonds that is considered appropriate. Furthermore, it is determined which rules shall apply to the resting place 25 and who shall manage it and by who and how it may be accessed, and which measures/work may be carried out within the boundary as well as whether the area is to be illuminated by, for example headlights 33. And the resting place 25 must be given an internationally accepted protection against exploitation and treated as a burial ground. Furthermore, the permitted amount of pollution on and in the diamonds 27 should be determined, and possible divide the resting place 25 to different countries, species, compacted area 81 etc. Furthermore, a suitable location to place the landing sites 65 should be planed as well as how roads 69 should be placed between the landing site 65 and the resting please 25 and other required infrastructure and interesting targets to travel on the celestial bodies 59. Furthermore, the terrain in which the machine will travel should be scanned and photographed from above and all collected data should be stored with coordinates in the digital map 35 on which the machine travels and works. And also planned roads 69, landing sites 65 and the resting place 25 should be given coordinates, for example the resting place outer limits and here also called borders. And area of the resting place to be compacted 81 prevents the diamonds from disappearing into the ground 79 should be shown on the map 35. Information from cameras 82 and other sensors on the machine is continuously transmitted to the operator placed on Earth when any of the machines described here are used, in a known manner from for example NASAs rovers on mars.

In the absence of a GPS system, the desired location or areas on a celestial body can for example be located as follows and where of course said searched location is stored in the control unit's 52 storage unit and adapted to the search method and equipment used. In this example a spacecraft 3 orbiting a celestial body 59 is described and comprising radar arm 74, which is rotatable and hinged and the movements of which are controlled by means of electronic circuits. At the free end of the radar arm 74 a sensor is arranged for sensing conditions and the surface 79 of the celestial bodies, which in this embodiment is a screen of a radar unit 80. This contains both a transmitter and a receiver for suitable radar wavelengths. Received echo signals are delivered to a control unit 52 placed inside the spacecraft 3 for performing an evaluation. Furthermore, a sensor, not shown, is provided for determining the position and the angular position of the radar screen 80 in relation to the spacecraft 3. The signals from the position sensor are also supplied to the control unit 52. Sensors of different kinds for determining the location of the resting place 25 and the surrounding area characteristics can be used, which have in particular been developed for military purposes. Here in addition to radar 80, lidar, laser, IR-systems, acoustic systems, and camera systems and of course GPS can be mentioned.

In FIG. 1 is shown an apparatus for transporting of diamonds 27 from earth to space or a resting place 25, placed on a celestial body 59 which in this example is the Moon. The main part of the apparatus is an automatic navigating and flying spacecraft 3 and which possibly can be maned and also transport other form of payloads. The spacecraft 3 can be designed to land on the surface of the celestial bodies 59 or sending a landing module 23, as shown in FIG. 5, to land on a landing site 65 on the celestial bodies 59 and after landing the spread/placement of the diamonds 27 on a resting place 25 can be performed by people or a machine. In order to determine the speed and position of the spacecraft 3 and the landing module 23 in relation to the landing site 65 or the resting place, a navigation system comprising GPS 57 are preferably used and placed on GPS satellites 57 or on the ground in a known manner from earth.

And to lover the problem with dust when landing and travel on roads 69 between the landing site 65 and the resting place 25 so are the surface 79 on all these places compacted/compressed 81 and hardened with a roller compactor 7 or a vibrating plate compactor 9. The spreading of diamonds can, after the spacecraft have landed, for example be done by humans in any suitable way. For example, by throwing the diamonds by hand and sprinkle the diamonds on the ground 79 so that the diamonds are visible or bury the diamonds in the ground and depending on, for example the owner of the diamond's requests. The diamonds 27 can also be spread by a movable diamond spreading machine 31 that can be driven by a human or autonomously, or that the moving parts of the machine can be remotely controlled from a Control Center 1 placed on Earth. The spreading of diamonds by a machine can for example be made by a planting assembly 13 placed on a planting arm 11 and place each diamond on or in the ground at a determined place on the resting place 25. And may, for example consist of a specific pattern or distance between the diamonds and can be spread visible on the ground surface 79 or placed at a specific depth in the ground. The position of scattered diamonds is stored in the storage unit of the machines computer unit 53 and can be used in later dispersal/spreading of diamonds. The spreading of diamonds from ground level can also be done by simply tilting the container 22 with diamonds or open a hatch or a nozzle 15 in the bottom of the container 22. When using a landing module 23, it can be stationed at the landing site 65 and pick up and drop off cargo between the landing site 65 and various spacecrafts 3, or the landing module can later be reconnected with the spacecraft 3 and after completing the mission return to Earth.

Here is also described a way to spread diamonds 27 on the resting place 25 from a distance, where the spacecraft 3 travel over the resting place 25 and where the diamonds 27 are released/dropped from the container 21 through an openable hatch or nozzle 15 or pushed/shoot in a suitable way from the spacecraft 3 in order to land on the said resting place 25. The resting place 25 can be located by the spacecraft 3 by using, for example GPS antenna 54 and calculate the signals from the GPS satellites 57 and or GPS systems placed on the surface 79 of the celestial bodies 59, in here known way from navigation on Earth. The resting place 25 can also be found by the spacecraft 3 by using sensor technology as described earlier, for example radar 80 or camera-systems where the surface of the celestial bodies 59 is identified by the controller comparing information from the sensors with stored information in a storage device. Both systems are here described in a preferred version in order that the spacecraft 3 also can operate on a celestial body 59 that not have GPS 57 or equal systems.

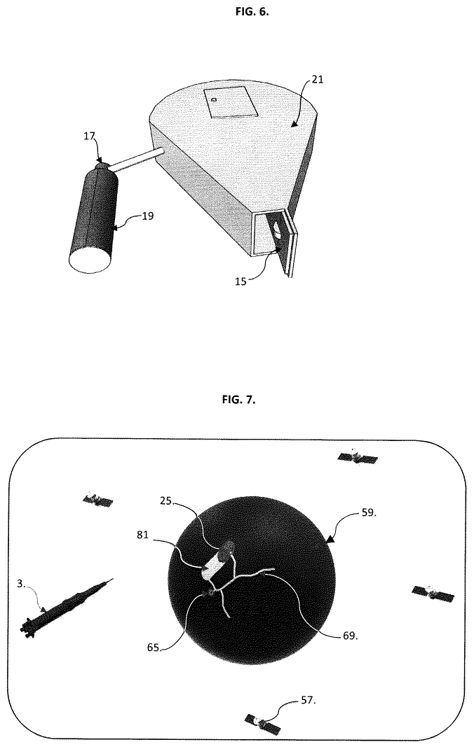

In FIGS. 2 and 7 is shown an apparatus and method for the spread of diamonds from a spacecraft 3 traveling over the celestial bodies 59 and can be simplified with a so-called flip maneuver 63 as described earlier and performed by the spacecraft's computer unit 52. And which activates and deactivates all the organs and functions described here by sending signals to these in a manner known for this maneuver, and the position correction air nozzles 16 are used in all today's spacecrafts. Where the spacecraft 3 is turned around 180 degrees by activating said air-nozzles 16 on the sides of the spacecraft, and the spacecraft for a while travels backwards through activation and automatic control of both the jet-engines 29 and the air nozzles 16. And the jet-engines 29 is directed in the direction of travel and activated and brake until the spacecraft 3 is stationary over the resting place 25 for a short time with the nozzle/hatch 15 facing the resting place 25 on the celestial bodies 59. Furthermore, an overpressure is created in the container 21, for example as shown in FIG. 6 and containing the diamonds 27 and by opening a motorized gas-tap 17 to a gas container 19. Then the motorized nozzle 15 placed on the bottom of the container 21 comprising the diamonds is opened after being activated by the controller 52 when the spacecraft 3 is stationary over the resting place 25 and the diamonds blows out through the nozzle 15 in the direction of the resting place 25. Where and when said flip maneuver 63 should be performed depends on the location and size of the resting place 25, and of course on the speed, weight, and braking ability on the spacecraft 3. Future, the spacecraft is affected of the celestial body's gravitation at the selected speed, and distance from the Moon or Mars. And, for example, when the speed falls below a specific level, the celestial bodies so-called escape speed, so will the spacecraft start fall towards the celestial bodies 59.

And the fall speed increases throughout the deceleration until it reaches so-called free fall, and which here occurs when the spacecraft has fully decelerated. But in this invention, see FIG. 2, this can be compensated for by directing the jet engines 29 slightly downwards toward the celestial bodies 59 throughout deceleration to counteract the effect of gravity on the spacecraft 3. Where the angle or applied force of the jet-engine 29 must increase the slower it goes, because an increasing lifting force is required for the height above the ground 79 to remain constant.

The spacecrafts 3 fall rate after doing the flip maneuver 63 can also be compensated for by using the air nozzles 16 used in the flip maneuver 63 and blow in the direction of the celestial bodies 59 and compensate for the gravitational forces from the celestial bodies 59. The lever action means that the effect increases if the air nozzles 16 are placed near the spacecrafts end point in a known manner for a flip maneuver 63 and on opposite sides, but to create the braking effect in free fall, it is advantageous to activate air nozzles 16 at both end points of the spacecraft on the same side as the nozzle 15 with said air nozzles 16 directed downwards. The preferred execution of the flip maneuver 63 should be stored in the computer unit 52.

One example embodiment to spread diamonds after a flip maneuver:

The function of the apparatus will now be described for at least one embodiment. The apparatus in the form of a spacecraft 3 is assumed to move continuously forwards at a pre-determined orbit, direction, and speed. The radar screen 80 is made to laterally scan over the celestial bodies ground surface area below the spacecraft 3 and at the same time issuing radar waves of a suitable wavelength. The received echo signals are transmitted to the central control unit 52. At the same time, the signals of the GPS 57 via antenna 54 are provided to the control unit 52, which correlates measured echo signals with different points on the ground by evaluating both the signals from the position sensor and received position signals as to the absolute location of the spacecraft 3.

The determined data are stored and then evaluated for determining the spacecrafts' exact location over a map 35 of the celestial bodies 59 in order to locate the in a storage unit stored location in the form of coordinates for the resting place 25 where the diamonds 27 should be spread. Then as input parameters are the stored specific location in space where a flip maneuver 63 should be conducted and comprising travel direction, altitude, and speed. And at said specific location, the controlled turning of the spacecraft 3 takes place by first turning off the jet engines 29 and activate the continuously monitored air nozzles 16 on the side of the spacecraft and push the spacecraft in for a flip maneuver 63 known manner until the spacecraft is pointed in the desired direction. When the spacecraft 3 is at least close to stationary, an electric motor is activated by the control unit 52 which controls all organs and functions on the spacecraft and the activated electrically controlled motor open a gas tap 17 connected to a gas container 19 so that expanding gas flows into the container 21 containing diamonds 27. Furthermore, the container 21 is equipped with an openable door or nozzle 15 and which can be opened by an electric motor activated by the control unit 52 or by the increased air pressure in the container 21 and directed towards the resting place 25 so that the diamonds are blown out of the container at a velocity higher than the falling velocity of the spacecraft 3. And the high-pressure air flowing out of the container through the door/valve/nozzle 15 will ensure that no diamonds 27 remain in the container 21. When all diamonds are out the spacecraft and confirmed by for example a camera inside the container 21 the controller 52 can activate the jet engines 29 and stop the falling by start to travel in the direction the spacecraft 3 came from.

The spacecrafts fall rate after doing the flip maneuver 63 can be compensated for as previously described by tilting the spacecrafts jet engines 29 slightly towards the celestial bodies 59 during the brake maneuver or using the air nozzles 16 used in the flip maneuver 63 to blow in the direction of the celestial bodies and compensate for the gravitational forces from the celestial bodies. The lever action means that the effect increases if the air nozzles 16 are placed near the spacecrafts end point in a known manner for a flip maneuver and on opposite sides, but to create the braking effect in free fall, it is advantageous to activate air valves at both end points of the spacecraft on the same side as the nozzle 15.

In FIG. 2 is shown a schematic view of one example of making a flip maneuver 63 and where fig. A, B, C, and D shows example of the spacecrafts 3 position during the flip maneuver, and fig E and G shows the direction of flight. And fig. F shows where the spacecraft stands still or is nearly sill and where the spreading of diamonds can start. And the maneuver starts after the jet engine 29 has been turned off, fig A, at determined speed, altitude, and direction in order to stand still over the resting place 25. The first air nozzle 16 to be activated are preferably located at the front of the spacecraft on the side towards the celestial bodies 59, and nozzle 16 located on the upper side at the rear. And pushes, fig B, so that the spacecraft 3 is pushed around with the jet engines 29 with a downward direction towards the celestial bodies 59 and the jet engines 29 is started again at the desired angle, fig C, and can in this way be made to both slow down the speed and maintain altitude and stop further rotation. The braking distance can of course be significant longer than the schematic description here shows. Well to notice is that with the described method the part of the spacecraft 3 which was directed towards the celestial bodies will be directed upwards when the flip maneuver 63 is completed. And why the nozzle 15 in this embodiment must be positioned to point downwards now when the flip maneuver 63 is completed. The flip maneuver 63 can also take place sideways and the spacecraft 3 always have the same side pointing down to the celestial bodies 59. But when using jet engine 29 to counteract gravity, the risk of lateral displacement increases.

Furthermore, selected parts of the celestial bodies can be illuminated to be visible from earth even when, for example, the resting place 25 is not illuminated by the sun. The lighting is advantageously made up of infrared light 33 so that it is not visible to the naked eye or with ordinary binoculars.

### Example of Apparatus and Method for Spreading Diamonds

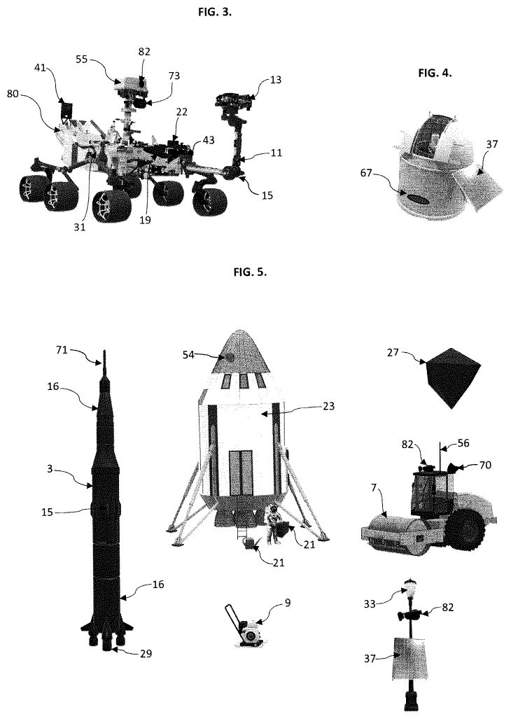

In FIG. 3 a diamond planting machine 31 is shown and designed to be able to travel and plant/spread diamonds 27 on or in the surface/soil 79 on the Moon and Mars and is in one embodiment equipped with a seat and control device for a driver. And in a preferred embodiment radio-controlled from a control Center 1 via its antenna 72 and the planting machines antenna 73 and equipped with a battery-powered motor as well as cameras 82 and censors etc. And all electrically controlled and moving organs is controlled in a known manner for remote driving and remote control, for example used on rovers on Mars and remote control of almost any type of equipment is naturally quite common here on earth. The difference is that the transmitter and receiver equipment must work over a long distance, and the time delay of a couple of seconds each way when operating the vehicles on the moon. And for the communication can be mentioned the equipment NASA use and called the Dep Space Network (DSN).

The main part of the planting machine 31 is an all-terrain vehicle and preferably radio-controlled from a Control Centre 1 on Earth. The planting mechanism and the machines' function have been further developed from the Canadian patent CA2282672 C called A Planting Machine, but instead of plants and seeds, it has been adapted to plant diamonds. And can of course also be designed to work fully or partially automatically where only new instructions need to be sent to the machines control unit 52 and essentially works according to pre-programmed instructions and also following new commands from said Control Centre 1. In one embodiment, the apparatus consists of a diamond planting machine 31 and a separate soil compaction unit shown in FIG. 5 in the form of a roller compactor 7 or plate compactor 9, also called a vibrator, but can of course also consist of a combined unit. And can be designed to be self-propelled with a separate engine for propulsion, or to be towed behind said planting machine 31 or, for example, an all-terrain vehicle.

The units in this innovation can be used individually, for example by first compacting the soil/surface 79 with a roller compactor 7 at specific locations such as roads 69 to the resting place 25 and planed places to work, for example around a charging station 67 or a bungalow for humans. And also compacting the soil surface 79 and hardening the landing sites 65 for the spacecraft 3 or a landing module 23 and parts of the resting place 25 so that the diamonds become visible on the surface 79. Then the vehicles can travel more easily on the shortest route, for example, the diamond planting machine 31 can travel on the hardened road 69 from the charging station 67 to the landing site 65 and after having picked up the diamonds 27 travel on road 69 to the resting place 25 and plant/spread diamond 27 on the hardened part of the resting place 25 where the diamonds 27 will stay visible, or travel to an undisturbed area of the resting place 25 where the diamonds 27 can be buried in the surface 79. After the work is done, the diamond planting machine 31 returns to the initial position in the charging station 67 and charge the battery. And the location of work done is stored with coordinates and displayed on a map 35 comprising at least the here mentioned and or prepared area of the Moon or Mars.

The location and area for the resting place 25 and the landing site 65, and the area that may be entered for roads 69 or various activities are advantageously given coordinates and how work should be done in the respective place and stored in the respective machine's computer unit's storage unit. But the information can, of course, also be transmitted in real time from said Control Centre 1, and all activity can continuously be monitored by the control centers 1 computer unit 51. Furthermore, all compacted/hardened surface material are given names and or number, for example the resting place 25, landing sites 65, charging station 67 and roads 69. And at road intersections signs are placed with information about where the roads leads and the distance, for example, a resting place 2 kilometers and a landing site 1.5 kilometer. The roller compactor 7 and the plate compacter 9 can be designed to be dragged/towed or activated and controlled wirelessly via the antenna 70 in the same way as the planting machine 31 from a control center 1 located on Earth. But can of course also be made to perform desired work tasks automatically according to criteria stored in the computer unit 50 in a manner known for this purpose or driven and operated by a person on site in the same way as these machines most often are used here on earth.

At the front most part at the front of the diamond planting machine 31 shown in FIG. 3 a radar arm 43 is provided, which is rotatable and hinged and the movements of which are controlled by means of electrical circuits. At the free end of the radar arm 43 a sensor is arranged for sensing conditions and surface 79 of the soil, which in the illustrated embodiment is a screen of a georadar 5. And in this example the equipment is placed on a diamond planting machine 31 but can also be used on a compactor unit to avoid rocks and potholes and other obstacle. The georadar 5 contains both a transmitter and a receiver for suitable radar wavelengths. And in this example the received echo signals are delivered to a control unit 53 placed inside the machine for performing an evaluation. Furthermore, a sensor, not shown, is provided for determining the position and the angular position of the georadar screen in relation to the planting machine 31. The signals from the position sensor are also supplied to the control unit 53. Sensors of various kinds for determining soil characteristics can be used, here in addition to soil penetrating radar, georadar, IR-systems and acoustic systems and camera systems can be mentioned.

On a part of the machine 31 at least one planting arms 11 are provided, and which is rotatable and hinged. The planting arm 11 carry at the free end diamond planting assemblies 13. The arm 11 can be designed so that the planting assemblies 13 always have a substantially vertical axis. In the same way as above sensors, not shown, are provided for determining the position of diamond planting assemblies 13 in relation to the planting machine 31 and the signals from the position sensors are supplied to the control unit 53. Furthermore, at 55 an GPS antenna is illustrated which is mounted at the machine 31 and is intended for wireless communication such as with GPS-satellites 57 or with for example antennas located on the ground 79 for an absolute determination of the position of the planting machine 31. And all collected data and images from the cameras 82 are continuously forwarded via antenna 73 and monitored by the Control Centre 1 on Earth via the antenna 72.

The function of the machine will now be described. FIG. 3 shows the diamond planting machine 31 and is assumed to be stationed at a charging station 67 when not in use, see FIG. 4. Where it charges the batteries through contact with the charging unit which can be designed in a similar way as, for example for automatic charging of lawnmowers, and the charging station 67 is charging its own batteries using solar panels 37. When a spacecraft 3 or landing module 23 has landed on the landing site 65 the Control Centre 1 sends instructions to the diamond planting machine 31 to be activated and approach the hereafter called spacecraft. The spacecraft can, for example, be equipped whit a pipe and blow out the diamonds from the container 21 placed in the spacecraft through a pipe to a container 22 placed on the planting machine 31. All these maneuvers can be performed automatically or by an operator using cameras and sensors and continuously know what is happening. The placement of diamonds 27 in the planting machines container 22 can of course also be made by an astronaut. The diamond planting machine 31 then travel on the hardened road 69 to the resting place 25 driven by a driver or autonomously or controlled by an operator via radio signals in known manner and located on the control Center 1. Due to the time delay between the Earth and the moon and of course especially mars, it is important that all fully or partly automated machines is equipped with cameras and other censors to avoid damage or getting stuck in the terrain. And can automatically perform emergency stop and obstacle avoidance, in ways known from for example autonomous cars.

And on the resting place 25 the radar screen 5 is made to laterally scan over the ground area 79 in front of the vehicle at the same time issuing radar waves of a suitable wavelength. The received echo signals are transmitted to the central control unit 53. At the same time the signals of the position sensor are provided to the control unit 53, which correlates measured echo signals with different points on the ground 79 by evaluating both the signals from the position sensor and received position signals as to the absolute position of the planting machine 31. The echo signals are evaluated and in particular for each point of the scanned ground surface the depth of soil and the size of free area of the ground 79 are determined in horizontal directions, i.e., in all different horizontal directions as viewed from each considered point. In particular different obstacles located in or above the soil layer can be determined as to their horizontal and vertical positions, their shape, etc. And the computer unit 53 decides whether detected obstacles can be driven over or whether it must be driven around, and if the obstacle is difficult to pass the machine should stop and wait for new orders from the operator. The determined data are stored and then evaluated for deciding suitable rout of travel and for the planting machine 31 traveling on the resting place 25 also the planting locations for diamonds 27 if the stored or desired location cannot be implemented. Then as input parameters the desired density and depth of the planting is used, which for example can be indicated as the number of diamonds per square meter and from for example 0-15 centimeters below the surface 79. The diamonds can be screwed or blown from the container 22 via a tube/pipe attached to the planting arm 11 down to the diamond planting assemblies 13 which places the diamonds on the ground with a preset distance between the diamonds or sticks down the said diamond planting assemblies 13 to the desired depth in a known manner from planting machines intended for planting, for example, seeds potatoes or trees. Furthermore, data in regard of already planted diamonds are used in the determination of suitable places. The determined new planting locations are stored.

At locations to be hardened by compressing the surface 79 the operator placed on Earth sends signals to activate the control unit on, for example, an off-road vehicle that can tow the roller compactor 7, or a plate compactor 9. The said compactors can also be equipped with an electric motor for propulsion and maneuvers in the same way as the planting machine 31. Where the machine can be controlled so that it travels at a selected speed and in a selected route and performs the desired compaction of the ground 79 at the specified location, and where the words compacting and compressing in this innovation has the same meaning. Said machines are also equipped with cameras 82 and the information is of course forwarded to the operator in the control center 1 in the same way as for all monitored sensors and maneuverable organs, for example for speed and direction of movement. Furthermore, all the machines described here are advantageously equipped with censors that monitor the environment around the machine and stop or steer the machine away when obstacles are detected, where the time delay from and to the celestial bodies 59 prevents the operator on the control center 1 from reacting in time. The surface compacting machines 7 or 9 are all the time controlled in a suitable way so that their compressing assemblies during a period generate a constant pressure or vibrates against the surface 79 at the intended location, though the machine all the time is moving forwards. It is achieved by the control unit all the time receiving signals from the GPS 57 received through the antenna 56, which indicate the absolute geographic position of the machine.

In the same way collects information and works the control unit 53 on the diamond planting machine 31 and at each designated location in the resting place 25 controls the planting arm 11, so that the planting assemblies 13 are placed over the planting locations and there can plant one or more diamonds. The arm 11 are also here controlled all the time, so that it is rotated horizontally and are prolonged or shortened in a suitable way, whereby the planting assemblies 13 during a sufficiently long period can stand quite still over the intended planting/spreading place, when the machine 31 all the time slowly runs forwards.

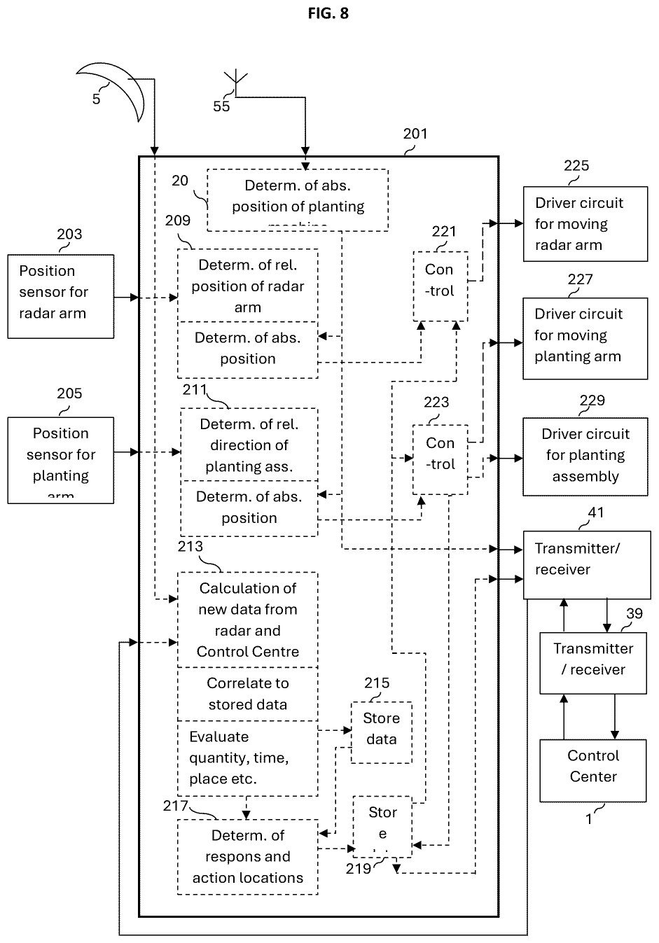

A block diagram of the electronic circuits of the planting machine is illustrated in FIG. 8. A central control unit 201 in the shape of a processor or a multitude of processors working in parallel receives signals from the GPS-antenna 55 from the GPR radar screen 5 and from the position sensors 203 and 205, associated with the positions of the different arms 43, and 11 respectively. The control unit 201 works according to a control rule, which can be divided in a number of processes or program routines working in parallel, which naturally can receive and transmit information to each other.

A program routine 207 processes the GPS-signals and determines at each instant the exact absolute geographic position of, in this example, the planting machine 31 and its absolute movement direction. Processes 209 and 211 process the signals from the position sensors 203 and 205 respectively and determines based thereon the instantaneously true values of the position of the respective assembly in relation to the planting machine 31, i.e., the position in the height direction and horizontally and the angular position of the GPR radar screen/arm 5, and the positions of the diamond planting assemblies 13 in horizontal directions.

Then the positions are absolutely determined by accessing information as to the absolute position of the vehicle from the module 207. A process 213 processes the signals from the GPR radar 5 for determining depth of soil, obstacles, etc. and correlates the calculated data with the correct absolute geographic position by receiving current position data from the module 207. The calculated data values are stored in a mass storage 215. The stored data of the ground are then further evaluated in a module 217, which in an optimal way determines diamond planting locations. For the determination the position determining module 217 also has access to the positions of already planted diamond's locations, which are stored in a memory 219. After having determined new planting locations, the positions thereof are stored in the memory 219.

Control processes 221 and 223 control the different movable parts of the diamond planting machine 31, i.e., the movement of the radar arm 43, the movements of the planting arm 11 and energizing the planting assemblies 13. For this control they have access to the current position of their respective arm and for all arms except the radar arm 43 the determined positions of new diamond planting places. The control modules 221 and 223 transmit signals to driver circuits for the different components. The control module 221 thus transmits signals to driver circuits 225 for operating the radar arm. The control module 223 transmits in the corresponding way signals to driver circuits 227 for operating the planting arm and to driver circuits 229 for operating the planting assembly. When a planting operation has been made, a signal is transmitted to the memory 219 to mark therein, that now a planting of one or more diamonds has been made on this place or area and can be displayed on a map 35. The Signals in regard of the current position of the vehicle and data referring to previously planted places and new selected planting places can be placed on the map 35 and transmitted to a display, which can be mounted in the vehicle and in the Control Centre 1. On it can be displayed the position of the planting machine 31 and the planting places and compacted and hardened roads 69 and landing site 65. When observing the display, the operator of the vehicle can select such a road that the machine runs at a suitable distance from previously made plantings and avoid obstacles. The entire vehicle and all moving parts and the status of all components and including the battery status and the number of planted diamonds can be followed in real time from the Control Center 1. The information transmitted to the control Center 1 comprises cameras 82 placed both on the machine 31 and in the surroundings. In FIG. 7 is shown an example of a map 35 shown on a display on a control center 1 and where all equipment has GPS and are calculated to their exact place in space and on the celestial body, or a specific part of it. And can also show hardened places on for example the moon and mars, for example hardened roads, resting places, or landing places and in combination with cameras on the equipment used.

Example of least one embodiment with a barrel assembly.

In at least one embodiment at a position of the spacecraft 3, a barrel arm 77 is arranged inside the spacecraft and which are rotatable and hinged and at the free end carry barrel assemblies 75. Such a barrel arm 77 can be designed so that the direction of the barrel assembly 75 always has a substantially vertical axis and can shoot diamonds loaded in the barrel in desired direction through an openable nozzle/hatch 15 in the spacecraft 3. Here also a sensor, not shown, is provided for determining the position of the barrel assembly 75 in relation to the spacecraft 3 and the resting place 25. The signals from the position sensor are in the same way as above supplied to the control unit 52. The nozzle 15 is connected to the spreading barrel assembly 75 for automatic distribution of diamonds 27 from a container 21. The nozzle 15 can be designed so that the barrel assemblies 75 always have a substantially vertical axis towards the celestial bodies surface. In the same way as above sensors, not shown, are provided for determining the position of barrel assemblies 75 in relation to the spacecraft 3 and the signals from the position sensors are supplied to the control unit 52. Furthermore, at 54 an antenna is illustrated which is mounted at the spacecraft 3 and is intended for wireless communication such as with GPS-satellites 57 or with for example GPS devices located on the ground for an absolute determination of the direction of travel and location of the spacecraft 3.

The location in the orbit the spreading of diamonds 27 should be made is determined by the controller 52 and navigate to the target location, which for example can be indicated as the coordinate in said orbit to activate the spreading assembly 75, or the barrel arm 77. Furthermore, data in regard of specific condition of the celestial bodies are used in the determination of best suited location to activate the selected spreading assemblies 75. The determined location for spreading of diamonds 27 is stored. The control unit controls the barrel arms 77, so that the nozzle 15 assemblies is directed at the intended calculated direction for spreading, for example drop or shot diamonds 27 against the celestial bodies resting place 25. The barrel arms 77 are all the time controlled, so that they are rotated horizontally and are prolonged or shortened in a suitable way, so that their spreading assemblies 75 during a predetermined period is directed in the determined direction in the spreading location, though the spacecraft 1 all the time is moving forwards. It is achieved by the control unit 52 all the time receiving signals from the position sensors on the barrel arms 77 and evaluating them together with the signals received through the antenna 71, which indicate the absolute geographic location of the spacecraft 1. In the same way the control unit 52 at the same time also controls the spreading assembly 75, so that the spreading assemblies 75 is directed against the resting place 25 placed over the prepared spreading locations and there can spread the diamond. The barrel arms 77 are also here controlled all the time, so that it is directed in a suitable way, whereby the spreading assemblies 75 during a sufficiently long period can be directed against the intended resting place, when the spacecraft 3 all the time travel forwards.

One embodiment of the diamond transport and spreading system 300 will now be described. Referring to FIG. 1 to 8. The apparatus in the form of a spacecraft 3 is assumed to use jet engine 29 and a pre-programmed computer program 49, not shown, to automatically move from a launch site on Earth to a specific orbit around the celestial bodies 59, for example the Moon. And transport the diamonds 27 in a container 21. The location in space for the celestial bodies 59 and the resting place 25 is determined in a coordinate system and also the orbital distance to the celestial bodies 59, direction of travel and speed, and can for example be made to work according to navigation systems used here on Earth. And determine an orbit and the location in the orbit to shot or drop to the diamonds 27 against the resting place 25. A control Center 1 placed on Earth control and supervises the whole operation, and in shown example the diamonds 27 is dropped against the resting place 25 on the Moon 59.

The controller in a computer unit 52, not shown, in the spacecraft 3 automatically controls, navigate, steers and adjust speed and direction of travel to the stored instruction and coordinates in the computer unit 52, storage unit, and places itself in the pre-programmed orbit around the celestial bodies and at said specified direction of travel and speed. Determined by the location of the resting place 25 to be used to spread the diamonds on. As well as the chosen distance between the spacecraft 3 and said resting place 25. The controller checks that the spacecraft 3 is in the desired direction and speed and, upon any detected and identified deviation from the pre-programmed direction and speed, jet-engines 29 are activated to stabilize and direct the spacecraft in the desired direction and speed. When the spacecraft 3 is in a designated location for distribution of diamonds 27, from at least one container 21, the computer unit activates, in this example, gas-tap 17, and creates an overpressure that squeezes out said diamonds 27 through at least one nozzle 15 opened to a specified level and continuously spreads a certain number of diamonds 27 in the desired direction.

An exemplary embodiment of an apparatus for transporting and spreading diamonds is described in a diamond spreading system 300. And using an exemplary embodiment of the apparatus shown in FIG. 3. System 300 comprises a determined location for a resting place 309 and includes an automatic diamond spreading machine 301 and a spreading device 302 and may be integrated into machine 301. Diamond spreading machine 301 includes GPS receiver 303 and a radar sensor, shown as radar unit 304. Spreading device 302 comprises a container 310 containing the diamonds 307 which are to be placed on the said celestial bodies 306. The diamond 307 is spread from the machine 301 in a specific direction, for example on or in surface in order to be spread on the resting place 309.

The details of the operation of system 300 are described below. In an alternate configuration, (as shown in FIG. 7), where the data is processed into a three-dimensional map of celestial bodies 306. The collected and calculated information is also sent in real time to the Control Center 311.

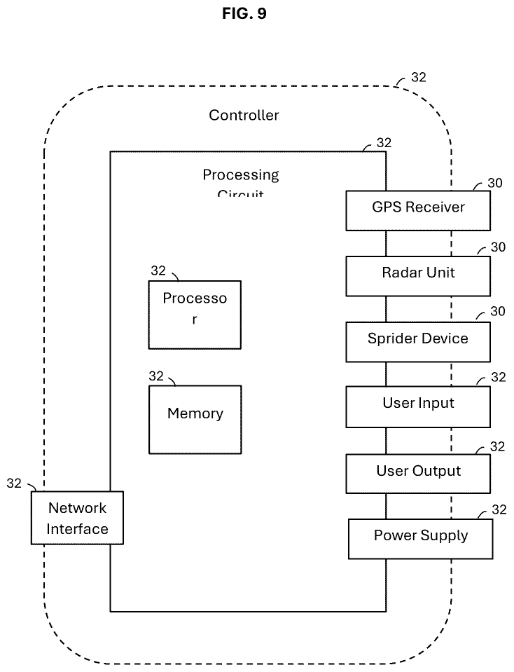

Referring to FIG. 9, a block diagram of controller 320 is shown. Controller 320 includes processing circuit 321. Processing circuit 321 includes processor 322 and memory 323. Processing circuit 321 communicates with GPS receiver 303, radar unit 304, spreading device 302, user input 324, user output 325, and network interface 326. Controller 320 is powered by power supply 327. Memory 323 stores necessary programming modules that when executed by processor 322, control the operation of spreading device 302 and the creation of the three-dimensional map of the celestial bodies 306 based on settings, parameters, and feedback signals received through input 324, GPS receiver 303, and radar unit 304. User input 324 is configured to provide an interface for a user to input desired operational parameters for system 300 (e.g., amount of diamond being placed in the container 310, desired spreading place, density of spreading, etc.). User input 324 includes a series of knobs, wheels, multi-position switches, a keyboard, a mouse, or any combination thereof, and connected to a computer device for direct input or wireless transmission in order to be taken over in real time by commands from the control center located on Earth.

User output 325 includes a display. User output 325 optionally includes audio output (e.g., for emitting beeps and tones) and/or indicator lights (e.g., LEDs for indicating system 300 statuses and alerts). It is contemplated that user input 324 and user output 325 are combined into a touchscreen display such that a user of system 300 can program desired settings and parameters through interaction with a graphical user interface presented on the display. Network interface 326 is configured to communicate with an external server or an external computing device, here called Control Center 311 and located on Earth. Power supply 327 provides power to controller 320. Power supply 327 may provide power to all components of system 300 (e.g., GPS receiver 303, radar unit 304, etc.). Power supply 327 may receive power from any suitable source (e.g., a rechargeable battery, solar panels, or a portable nuclear reactor etc.). Controller 320 is configured to process feedback signals from GPS receiver 303 and radar unit 304 based on provided operating parameters. As the diamond spreading machine 301 moves on the surface of the resting place 309 on the moon or mars, and controller 320 receives feedback signals from radar unit 304 that indicates detected surface characteristics and GPS receiver 303 that indicate the machines 301's location. Controller 320 processes these feedback signals into a detailed three-dimensional map of the celestial bodies 306. The threedimensional map includes location specific information pertaining to the composition of celestial bodies 306 (e.g., chemical composition, moisture, density, material presence, whether the soil is compacted or uncompacted etc.). The presence of craters and rocks and other objects, and other information pertaining to the resting place 309 up to a specified depth. The depth parameter of the three-dimensional map (e.g., the shape of the whole celestial bodies 306, for example in the form of the size and density of all parts of the surface etc.) and may be a user provided parameter. Equipment with GPS and their location can be placed on the map at known coordinates, for example, on the ground or over the planet and shown on a display. Controller 320 is configured to analyze feedback signals from radar unit 304 to locate and identify objects in the celestial bodies 306 (e.g., stones and holes, water etc.). Detected objects are identified by their radar signatures. For example, radar waves reflected off water will have a different signature than radar waves reflected off stones or sand. Controller 320 automatically determines the identity of different obstacles in the celestial bodies 306. Alternatively, manually identified and updated on the map through user input. For example, objects that cannot be automatically identified are marked as unknown on the map. The user then manually identifies the unknown objects, and the user can identify the object on the map and the object's identity can be stored. Alternatively, the user may choose to have the object remain unidentified.

As machine 301 moves along the resting place 309 on the celestial bodies 306, controller 320 instructs spreading device 302 to spread diamond 306. Spreading device 302 can spread diamond at varying deep, direction and densities, by for example, varying the degree of opening of a nozzle connected to the container containing diamonds, by sending a signal to an electric motor which regulates the opening of the nozzle. Where the spreading of diamonds can be carried out in any of the previously described ways. And based on user provided parameters and detected objects and the resting places 309 local conditions, controller 320 instructs spreading device 302 to spread a specific amount of diamond at specific locations and at specific time or time period. For example, controller 320 may instruct such that diamond 307 are placed in desirable locations and are not placed in undesirable locations (e.g., in a location where the diamond is either visible on the ground surface or buried, depending on the owner's desire etc.).

Upon the successful placement of diamonds 307 by spreading device 302, controller updates the map of the resting place 309 to indicate the placement of the diamond 307 (e.g., marks the map with an indication of the diamond 307 placement). The created map may be exported to an external computing device via network interface 326, stored in memory 323, or stored on removable storage media (e.g., SD memory card, MicroSD memory card, USB flash memory, etc.). The user can then reference the created map after celestial bodies 306 has been mapped and/or after diamond 307 have been delivered. And with knowledge of the previously placed diamonds, places for new placements can be calculated. The GPS for coordinate determination can be placed on satellites or on the surface of the celestial bodies 306. And all the collected information is sent to and processed by Control Center 311. The diamond planting machine 301 can of course be equipped to be driven by a driver or driven wirelessly from a Control Center 311 with certain functions fully automatic, and in a manner known for this.

The above systems and methods can be operated as part of a business:

The business offers may consist of transporting the diamond to space or a selected resting place, and may, for example, consist of agreements to spread/disperse/place a certain number of diamonds at a specified location and time. For example, from specific coordinates in space, or from a location or orbit around a specific celestial body so that the diamonds land in or on the ground or place the diamond on a specific place after the spacecraft has landed. The business offers may also include an insurance policy to provide a fixed protective effect over transporting the diamond to a specific place in space against payment. And calculated as a percentage risk of damage to what is insured.

The business offer may also include protection against specific disasters or the extent of disasters of some severity, such as failure of the spacecraft. The business offers can also cover insurance of diamonds, supplies and equipment for all stages and include, for example, manufacturing, transport, quality, and delivery reliability. The business offers may also include insurance of the equipment used to fill the spacecraft with supplies, diamonds, and fuel. The business offers may also include insurance against particles causing damage of a specific type or extent to, for example, satellites in an orbit or on travel to, for example, the Moon or Mars. The business offers may also include, for payment, spreading the diamond of deceased or deceased pets from said orbit around the celestial bodies. The business offers may also include transporting equipment for compacting the surface on the Moon or Mars, and compacting specific areas, for example on a resting place, roads, landing sites for spacecrafts or other places where vehicles or people will travel or be. The business offer may also include using the machines to determine ground conditions or lock for objects, materials or substances etc. for example meteorites or specific substances or metals, for example gold. Example of usable censors include cameras, GPRS and metal detectors. The business offers may also include training, and training to perform the tasks necessary to perform and manage any of the components and equipment of the invention. For example, for the manufacture, repair, and maintenance of the spacecraft as well as personnel at the Control center and the manufacture of diamonds. And for example, placing diamonds in space or on a celestial body or operate a diamond planting machine or compacting machine.

The business offers may also include salaries for staff working for the Control Center and for those who manufacture or transport the spacecraft, diamonds, supplies, software, spare parts, etc. The business offers may include insurance of all personnel and crew working with any of the components of the invention. The business offers can comprise to spread diamonds on a specific resting place. The business offers can also include a customer transporting services to customers who want to travel to space or orbit the Moon or Mars. Customers can purchase individual maps of an area of celestial bodies containing a resting place or compressed ground surface, for example roads, landing sites or specific infrastructure on a celestial body. Alternatively, customers can subscribe to recurring maps. The maps can be used for celestial bodies operations (e.g., spreading operations in the path, etc.). Additionally, the maps can be used to calculate future places to spread diamonds and, for example, that specific diamonds should be placed in specific locations in space or on a resting place. All the above-mentioned services are provided to customers for a fee. The business offers may also include to manufacture computer program as well as collect and store data about the origin of a specific diamond etc. and make the program searchable on the internet. Where the information may be optional or standardized. The business offers may also include to collect biological material and manufacture diamonds as well as all tasks that are necessary to carry out the work. And transport the diamond to space or a specific celestial body. The business offers may also include any of the methods and equipment used in this innovation. Although the above systems and methods refer to the spreading of diamonds, the above systems and methods may be designed in various form to spread diamonds. Accordingly, the business offers may also include information of diamond placed in space or any celestial body equipment that is transported to space can also be insured, as well as the ordered work to be carried out on the celestial bodies, for example spreading diamond on the resting place. As well as all equipment, for example to compact the ground, as well as the work or use what these machines performed or are performing.

The construction and arrangement of the systems and methods as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements.

The elements and/or assemblies of the enclosure may be constructed from any of a wide variety of materials that provide sufficient strength or durability, and in any of a wide variety of colors, textures, and combinations. Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word “exemplary” is intended to present concepts in a concrete manner. Accordingly, all such modifications are intended to be included within the scope of the present inventions. The order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes, and omissions may be made in the design, operating conditions, and arrangement of the preferred and other exemplary embodiments without departing from scope of the present disclosure or from the spirit of the appended claims.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures may show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

1. A method to process and transport organic matter originating from Earth to space and or one or more celestial bodies (59) in the solar system or beyond and comprising transport in a spacecraft and placing/spreading the organic matter in space or on the celestial bodies, characterized in that at least a part of the organic matter is in the form of at least one diamond (27); and, transported in a container (21); in the autonomous spacecraft (3).

2. The method according to claim 1, characterized in that it future comprising the steps of:
extracting carbon from cremated remains;
compressing the extracted carbon to form one or more diamonds;
transporting the diamonds to a designated location in space or on the Moon or Mars using a spacecraft (3);
spreading or planting the diamonds on the designated location; and,
controlling the spreading or planting of the diamonds from a control center (1) placed on Earth.

3. The method according to any one of claims 1 to 2, characterized in that the method comprising that the diamonds (27) are counted and or weighted.

4. The method according to any one of claims 1 to 3, characterized in that the method comprising that the celestial body(s) have at least one resting place (25) with determined borders where diamonds are spread/placed in or on the surface.

5. The method according to any one of claims 1 to 4, characterized in that the method comprising the use of an autonomous spacecraft (3) for transporting the diamonds and that the spacecraft is equipped for personal transports and or payloads.

6. The method according to any one of claims 1 to 5, characterized in that the method comprising the use of a movable vehicle on the celestial bodies surface to transport diamonds from a spacecraft/landing module to at least one resting place (25); and, place/spread the diamonds so that the diamonds are placed visible on the surface or buried in the surface material.

7. The method according to any one of claims 1 to 6, characterized in that the method future comprising of at least one of the following:
making an insurance policy covering at least part of the transport and spreading of diamonds;
making and or using a map (35) of at least a part of a celestial bodies with marked boundaries for at least one resting place (25) for spreading diamonds;
making a container (21) for transporting diamonds;
taking/showing a photography of a resting place;
making/showing a film comprising placing/spreading of diamonds on a resting place;
informing or broadcasting in any form and in any media about placing diamonds made of carbon from organic matter in space or on the Moon or Mars.

8. The method according to any one of claims 1 to 7, characterized in that the celestial bodies (59) ground surface material being compressed to reduce the problems of dust on at least a part of at least one of the following:
a resting place (25);
a landing site (65) for spacecrafts and landing modules;
a road (69).

9. The method according to any one of claims 1 to 8, characterized in that it future comprises storing information in a computer program (45) about each person and or animal spread/placed as at least one diamond in space or on the Moon or Mars; and, that the information include the name of the place where the diamond is placed; and, that the stored data is accessible via the internet.

10. The method according to any one of claims 1 to 9, characterized in that it comprises:
placing a control center (1) on Earth, the control center capable of controlling and communicate with at least one automatic flying spacecraft (3), and coupling a controller to said spacecraft capable of automatic flying to a determined location; and, future comprise at least one of the following:
transporting diamonds in at least one container (21) in said automatic flying spacecraft;
transporting a surface compressing machine (7) or (9) from Earth to a celestial body (59);
compressing the ground surface (79) on a part of a celestial body with said surface compressing machines (7) or (9);
transporting a diamond spreading machine (31) from the Earth to a celestial body;
spreading diamonds on a resting place (25) with said diamond spreading machine (31);
operating a diamond spreading machine or a surface compressing machine on a celestial body from a control center (1) placed on Earth;
naming a resting place (25) for diamonds on a celestial body;
naming a hardened landing site (65) on a celestial body;
naming a hardened road (69) on a celestial body;
placing named hardened surfaces on a celestial body on a map (35);
illuminating (33) the surface of a resting place (25);
using materials from the ground of the Moon or Mars to increase the weight of the surface compressing machines (7) or (9).

11. The method according to any one of claims 1 to 10, characterized in that it comprises:
advertising about the transportation of diamonds to space, the Moon or Mars;
collecting biological material from living and dead persons and animals;
making at least one diamond from collected material from each individual;
placing manufactured diamonds in at least one container;
placing said container in a spacecraft for further transport to a specific location in space, the Moon or Mars.
transporting the diamonds in said spacecraft to the desired destination.

12. A product in the form of at least in part compressed ground surface layer (79) on the Moon or Mars and produced with a roller compactor (7) or plate vibrator (9) controlled by a control center (1) on Earth, and comprising at least one of the following:
a resting place (25) for diamonds;
a landing site (67) for spacecrafts and landing modules;
a road (69);
a map (35) of a celestial body comprising location of said compressed ground surface (79).

13. An apparatus for treatment and transporting organic matter originating from Earth to space and or one or more celestial bodies (59) in the solar system or beyond and for placing/spreading the organic matter in space or on said celestial bodies, characterized in that at least a part of the organic matter comprising carbon in the form of at least one diamond (27) made of said organic matter.

14. The apparatus according to claim 13, characterized in that the apparatus comprise an autonomous spacecraft (3) for transporting at least one container (21) for diamonds (27) and a control center (1) located on Earth for controlling and communicating with the spacecraft.

15. The apparatus according to any one of claims 13 to 14, characterized in that its future comprises at least one resting place (25) on the Moon or Mars.

16. The apparatus according to any one of claims 13 to 15, characterized in that its future comprises at least one means for creating light directed against the surface of a resting place (25), for example means for infrared light.

17. The apparatus according to any one of claims 13 to 16, characterized in that it further comprises a diamond planting machine (31).

18. The apparatus according to any one of claims 13 to 17, characterized in that at least part of the spreading of diamonds on a resting place (25) further comprise means for spreading diamonds from a distance above the resting place (25) by a spacecraft (3) in orbit around the celestial bodies (59), or after that the spacecraft has performed a flip maneuver (63).

19. The apparatus according to any one of claims 13 to 18, characterized in that the apparatus future comprising at least one of the following:
a roller compactor (7);
a plate compactor (9);
a GPS system (57);
a map (35) of a celestial body containing at least one resting place (25);
a map (35) of a celestial body containing compressed ground surfaces;
a computer program (45) comprising information about the people or other organic matter spread/placed as a diamond in space or on a celestial body and that the stored data is accessible via the internet.

20. A use of a diamond resting place (25) with coordinate-determined boundaries on the Moon or on Mars for placing/spreading diamonds (27) made of carbon from organic matter originating from Earth.
